(19) United States
(12) Patent Application Publication
(10) Pub. No.: US 2002/0065857 A1
(43) Pub. Date: May 30, 2002

(54) System and method for analysis and clustering of documents for search engine

(76) Inventors: Zbigniew Michalewicz, Charlotte, NC (US); Andrzej Jankowski, Warsaw (PL)

Correspondence Address: McGuire Woods LLP, Suite 1800, 1750 Tysons Boulevard, McLean, VA, 22102, US

(21) Appl. No.: 09/920,732

(22) Filed: Aug. 3, 2001

Related U.S. Application Data
(60) Provisional application No. 60/237,792, filed on Oct. 4, 2000.
(60) Provisional application No. 60/237,794, filed on Oct. 4, 2000.
(60) Provisional application No. 60/237,795, filed on Oct. 4, 2000.

(51) Int. Cl. G06F 17/00

(52) U.S. Cl. 707/532; 707/500

(57) ABSTRACT

A system and method for searching documents in a data source and more particularly, to a system and method for analyzing and clustering of documents for a search engine. The system and method includes analyzing and processing documents to secure the infrastructure and standards for optimal document processing. By incorporating Computational Intelligence (CI) and statistical methods, the document information is analyzed and clustered using novel techniques for knowledge extraction. A comprehensive dictionary is built based on the keywords identified by the these techniques from the entire text of the document. The text is parsed for keywords or the number of its occurrences and the context in which the word appears in the documents. The whole document is identified by the knowledge that is represented in its contents. Based on such knowledge extracted from all the documents, the documents are clustered into meaningful groups in a catalog tree. The results of document analysis and clustering information are stored in a database.

### CROSS REFERENCE TO RELATED APPLICATIONS

The present application claims benefit of priority to U.S. provisional applications having serial Nos. 60/237,792, 60/237,794 and 60/237,795 all filed on Oct. 4, 2000. The present application is also related to U.S. applications entitled “Spider Technology for Internet Search Engine” (Attorney Docket No. 07100003AA) and “Internet Search Engine with Search Criteria Construction” (Attorney Docket No. 07100005AA), all of which were filed simultaneously with the present application and assigned to a common assignee. The disclosures of these co-pending applications are incorporated herein by reference in their entirety.

### BACKGROUND

### FIELD OF THE INVENTION

The present invention is generally related to a system and method for searching documents in a data source and more particularly, to a system and method for analyzing and clustering of documents for a search engine.

### BACKGROUND SECTION

The Internet and the World Wide Web portion of the Internet provide a vast amount of structured and unstructured information in the form of documents and the like. This information may include business information such as, for example, home mortgage lending rates for the top banks in a certain geographical area, and may be in the form of spreadsheets, HTML documents or a host of other formats and applications. Taken in this environment (e.g., the Internet and the World Wide Web portion of the Internet), the information that is now disseminated and retrievable is fast transforming society and the way in which business is conducted, worldwide.

In the environment of the Internet and the World Wide Web portion of the Internet, it is important to understand that information is changing both in terms of volume and accessibility; that is, the information provided in this environment is dynamic. Also, with technological advancement, more and more data in electronic form is being made available to the public. This is partly due to the information being electronically disseminated to the public on a daily basis from both the private and government sectors. In realizing the amount of information now available, corporations and businesses have recognized that one of the most valuable assets in this electronic age is, indeed, the intellectual capital gained through knowledge discovery and knowledge sharing via the Internet and the World Wide Web portion of the Internet. Leveraging this gained knowledge has become critical to gaining a strategic advantage in the competitive worldwide marketplace.

Although increasing amounts of information is available to the public, finding the most pertinent information and then organizing and understanding this information in a logical manner is a challenge to even the most sophisticated user. For example, it is necessary, prior to retrieving information, to

Realize what information is really needed,

How can that information be accessed most efficiently including how quickly can that information be retrieved, and

What specific knowledge would the information provide to the requestor and how the requester (e.g., a business) can gain economically or otherwise from such information.

Undoubtedly, it has thus become increasingly important to devise a sound search strategy prior to conducting a search on the Internet or the World Wide Web portion of the Internet. This enables a business to more efficiently utilize its resources. Accordingly, by devising a coherent search strategy, it may be possible to gather information in order to make it available to a proper person so as to make an informed and educated decision. Without such proper and timely gathered information, it may be impossible or extremely difficult to make a critical and well informed decision.

The existing tools for Internet information retrieval can be classified into three basic categories:

1. Catalogues: In catalogues, data is divided (a priori) into categories and themes. This division is performed manually by a service-redactor (subjective decisions). For a very large catalogue, there are problems with updates and verification of existing links, hence catalogues contain a relatively small number of addresses. The largest existing catalogue, Yahoo™, contains approximately 1.2 million links.

2. Search engines: Search engines build and maintain their specialized databases. Two main types of software is necessary to build and maintain such databases. First, a program is needed to analyze the text of documents found on the World Wide Web (WWW) to store relevant information in the database (so-called index), and to follow further links (so-called spiders or crawlers). Second, a program is needed to handle queries/answers to/from the index.

3. Multi-search tools: These tools usually pass the request to several search engines and prepare the answer and one (combined) list. These services usually do not have any “indexes” or “spiders”; they just sort the retrieved information and eliminate redundancies.

The current Internet search engines analyze and index documents in different ways. However, these search engines usually define the theme of a document and its significance (the latter one influences the position (“ranking”) of the document on the answer page) as well as select keywords by analyzing the placement and frequencies of the words and weights associated with the words. Additionally, current search engines use additional “hints” to define the significance of the document (e.g., the number of other links pointing to the document). The current Internet search engines also incorporate some of the following features:

Keyword search—retrieval of documents which include one of more specified keywords.

Boolean search—retrieval of documents, which include (or do not include) specified keywords. To achieve this effect, logical operators (e.g., AND, OR, and NOT) are used.

Concept search—retrieval of documents which are relevant to the query, however, they need not contain specified keywords.

Phrase search—retrieval of documents which include a sequence of words or a full sentence provided by a user usually between delimiters;

Proximity search—retrieval of documents where the user defines the distance between some keywords in the documents.

Thesaurus—a dictionary with additional information (e.g., synonyms). The synonyms can be used by the search engine to search for relevant documents in cases where the original keywords are missing in the documents.

Fuzzy search—retrieval method for checking incomplete words (e.g., stems only) or misspelled words.

Query-By-Example—retrieval of documents which are similar to a document already found.

Stop words—words and characters which are ignored during the search process.

During the presentation of the results, apart form the list of hits (Internet links) sorted in appropriate ways, the user is often informed about the values of additional parameters of the search process. These parameters are known as precision, recall and relevancy. The precision parameter defines how returned documents fit the query. For example, if the search returns 100 documents, but only 15 contain specified keywords, the value of this parameter is 15%. The recall parameter defines how many relevant documents were retrieved during the search. For example, if there are 100 relevant documents (i.e., documents containing specified keywords) but the search engine finds 70 of these, the value of this parameter would be 70%. Lastly, the relevance parameter defines how the document satisfies the expectations of the user. This parameter can be defined only in a subjective way (by the user, search redactor, or by a specialized IQ program).

Now, the conventional search engine attempts to find and index as many websites as possible on the World Wide Web by following hyperlinks, wherever possible. However, these conventional search engines can only index the surface web pages that are typically HTML files. By this process, only pages that are static HTML files probably linked to other pages) are discovered using the keyword searches. But not all web pages are static HTML files and, in fact, many web pages that are HTML files are not even tagged accurately to be detectable by the search engine. Thus, search engines do not even come remotely close to indexing the entire World Wide Web (much less the entire Internet), even though millions of web pages may be included in their databases.

It has been estimated that there are more than 100,000 web sites containing un-indexed buried pages, with 95 percent of their content being publicly accessible information. This vast repository of information, hidden in searchable databases that conventional search engines cannot retrieve, is referred to as the “deep Web”. While much of the information is obscure and useful to very few people, there still remains a vast amount of data on the deep Web. Not only is the data on the deep Web potentially valuable, it is also multiplying faster than data found on the surface Web. This data may include, for example, scientific research which may be useful to a research department of a pharmaceutical or chemical company, as well as financial information concerning a certain industry and the like. In any of these cases, and countless more, this information may represent valuable knowledge which may be bought and sold over the Internet or World Wide Web, if it was known to be available.

With the recent Internet boom, the number of servers has risen to more than 18 million. The number of domains has grown from 4.8 million in 1995 to 72.4 million in 2000. The number of web pages indexed by search engines has risen from 50 million in 1995 to approximately 2.1 billion in 2000. Meanwhile, the deep Web, with innumerable web pages not indexable by search engines, has grown to about 17,500 terabytes of information consisting of over 500 billion documents. Obviously, advanced mechanisms are necessary to discover all this information and extract meaningful knowledge for various target groups. Unfortunately, the current search engines have not been able to meet these demands due to drawbacks such as, for example, (i) the inability to access the deep Web, (ii) irrelevant and incomplete search results, (iii) information overload experienced by users due to the inability of being able to narrow searches logically and quickly, (iv) display of search results as lengthy lists of documents that are laborious to review, (v) the query process not being adaptive to past query/user sessions, as well as a host of other shortcomings.

Discovery engines, on the other hand, help discover information when one is not exactly sure of what information is available and therefore is unable to query using exact keywords. Similar to data mining tools that discover knowledge from structured data (often in numerical form), there is obviously a need for “text-mining” tools that uncover relationships in information from unstructured collection of text documents. However, current discovery engines still cannot meet the rigorous demands of finding all of the pertinent information in the deep Web, for a host of known reasons. For example, traditional search engines create their card catalogs by crawling through the “surface” Web pages. These same search engines can not, however, probe beneath the surface the deep Web.

### SUMMARY

According to the invention, a method for analyzing and processing documents is provided. The method includes the steps of building a dictionary based on keywords from an entire text of the documents and analyzing text of the documents for the keywords or a number of occurrences of the keywords and a context in which the keywords appear in the text. The method further includes clustering documents into groups of clusters based on information obtained in the analyzing step, wherein each cluster of the groups of clusters includes a set of documents containing a same word or phrase.

In embodiments, the groups of clusters are split into subclusters by finding words which are representative for each of the group of clusters and generating a matrix containing information about occurrences of the top words in the documents from the groups of clusters. New clusters are then created based on the generating step which corresponds to the top words and a set of phrases. The splitting may be based on statistics to identify best parent cluster and most discriminating significant word in the cluster. In further embodiments, the clustering may be performed recursively and may additionally include creating reverted index of occurrences of words and phrases in the documents, building a directed acyclic graph and counting the documents in each group of clusters. The clustering may further include generating document summaries and statistical data for the groups of clusters, updating global data by using the document summaries and generating cluster descriptions of the groups of clusters by finding representative documents in the each cluster of the groups of clusters. The clustering may also include finding elementary clusters associated with the groups of clusters which contain more than a predetermined size of the documents.

The analyzing step may also include analyzing the documents for statistical information including word occurrences, identification of relationships between words, elimination of insignificant words and extraction of word semantics, and is performed on only selected documents which are marked. The analyzing step may also include applying linguistic analysis to the documents, performed on titles, headlines and body of the text, and content including at least one of phrases and the words. The analyzing step may also include computing a basic weight of a sentence and normalizing the weight with respect to a length of the sentence. Thereafter, ordering the sentences with the highest weights in an order which they occur in the input text and providing a priority to the words by evaluating a measure of particular occurrence of the words in the documents. The keywords may then be extracted from the documents which are representative for a given document.

### BRIEF DESCRIPTION OF THE DRAWINGS

FIG. 1 is a block diagram of an exemplary system used with the system and method of the present invention;

FIG. 2 shows the system of FIG. 1 with additional utilities;

FIG. 3 shows an architecture of an Enterprise Web Application;

FIG. 4 shows a deployment of the system of FIG. 1 on a Java 2 Enterprise Edition (J2EE) architecture;

FIG. 5 shows a block diagram of the data preparation module of the present invention;

FIG. 6 is a flow diagram showing the steps of the analysis clustering process of the data preparation module;

FIG. 7 shows a design consideration when implementing the steps shown in FIG. 6;

FIG. 8 shows a general data and control implementing the present invention;

FIG. 9 shows a case diagram implementing steps of the overall design of the search engine;

FIG. 10 shows an example for preparing data;

FIG. 11 is a flow diagram for the example shown in FIG. 10;

FIG. 12 is an example of the administrative aspect of the system functionality;

FIG. 13 is a flow diagram of the dialog control (DC)1 processing scheme;

FIG. 14 is a flow diagram showing an analysis of the documents;

FIG. 15 is a flow diagram describing the initial clustering of documents;

FIG. 16 shows the sub modules of the DC2 module of the present invention;

FIG. 17 shows a first stage analysis performed off-line and a second stage analysis performed on-line;

FIG. 18 shows the DC2 analysis sub-module;

FIG. 19 is a flow diagram implementing the steps for the indexing control of the DC2 Analyzing shown in FIG. 18;

FIG. 20 is a flow diagram implementing the steps for the DocAnalysis of FIG. 10;

FIG. 21 shows a diagram outlining the document tagging of FIG. 18;

FIG. 22 is a flow diagram implementing the steps of language recognition and summarizing;

FIG. 23 is a flow diagram implementing the steps of the dc2loader of the present invention;

FIG. 24 shows a case diagram for the template taxonomy generation (TTG);

FIG. 25 shows an example of clustering;

FIG. 26 is a high-level view of the completer module external interactions;

FIG. 27 shows a flow diagram of the steps implementing the processes of the completer module;

FIG. 28 shows an example of clustering;

FIG. 29 is a flow diagram showing the steps of the taxonomer module; and

FIG. 30 shows the sub-steps of decomposition described initially with reference to FIG. 29.

### DETAILED DESCRIPTION OF INVENTION

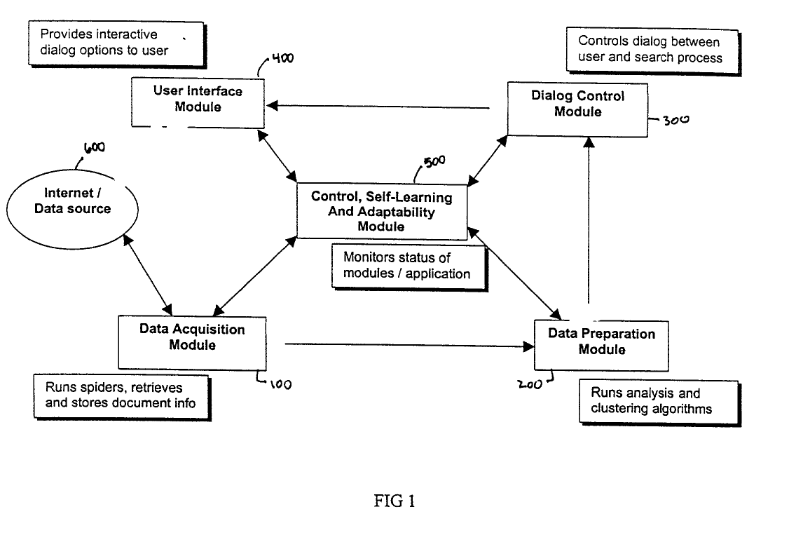

FIG. 1 represents an overview of an exemplary search, retrieval and analysis application which may be used to implement the method and system of the present invention. It should be recognized by those of ordinary skill in the art that the system and method of the present invention may equally be implemented over a host of other application platforms, and may equally be a standalone module. Accordingly, the present invention should not be limited to the application shown in FIG. 1, but is equally adaptable as a stand alone module or implemented through other applications, search engines and the like.

The overall system shown in FIG. 1 includes five innovative modules: (i) Data Acquisition (DA) module 100, (ii) Data Preparation (DP) module 200, (iii) Dialog Control (DC) module 300, (iv) User Interface (UI) module 400, and (v) Adaptability, Self-Learning and Control (ASLC) module 500, with the Data Preparation (DP) module 200 implementing the system and method of the present invention. For purposes of this discussion, the Data Acquisition (DA) module 100, Dialog Control (DC) module 300, User Interface (UI) module 400, and Adaptability, Self-Learning and Control (ASLC) module 500 will be briefly described in order to provide an understanding of the overall exemplary system; however, the present invention is directed more specifically to innovations associated with the Data Preparation (DP) module 200.

In general, the Data Acquisition module 100 acts as web crawlers or spiders that find and retrieve documents from a data source 600 (e.g., Internet, intranet, file system, etc.). Once the documents are retrieved, the Data Preparation module 200 then processes the retrieved documents using analysis and clustering techniques. The processed documents are then provided to the Dialog Control module 300 which enables an intelligent dialog between an end user and the search process, via the User Interface module 400. During the user session, the User Interface module 400 sends information about user preferences to the Adaptability, Self-Learning & Control module 500. The Adaptability, Self-Learning & Control module 500 may be implemented to control the overall exemplary system and adapt to user preferences.

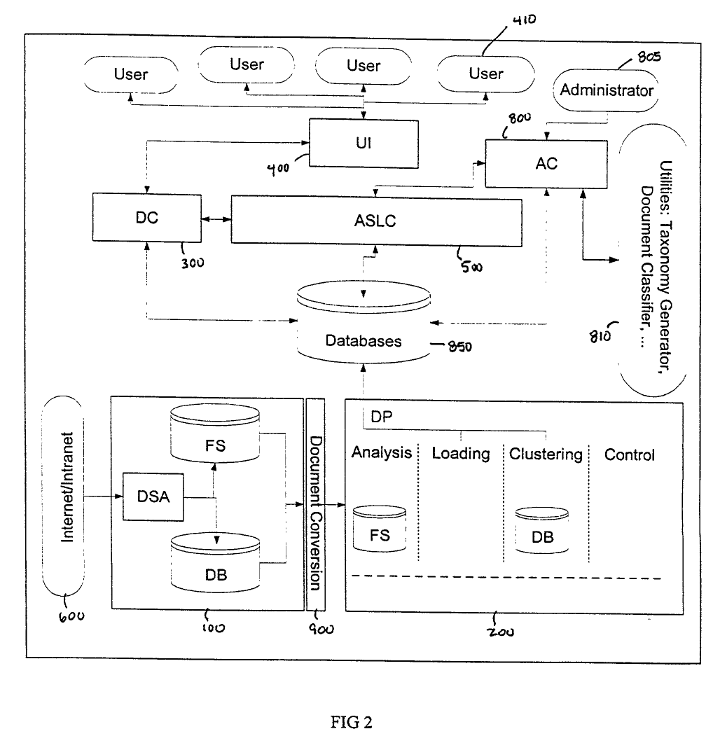

FIG. 2 shows the system of FIG. 1 with additional utilities: Administration Console (AC) 800 and Document Conversion utility 900. After the Data Acquisition module 100 receives documents from the Internet or other data source 600, the Document Conversion utility 900 converts the documents from various formats (such as MS Office documents, Lotus Notes documents, PDF documents and others) into HTML format. The HTML formatted document is then stored in a database 850. The stored documents may then be processed in the Data Preparation module 200, and thereafter provided to the User Interface module 400 via the database 850 and the Dialog Control module 300. Several users 410 may then view the searched and retrieved documents.

The Administration Console 800 is a configuration tool for system administrators 805 and is associated with a utilities module 810 which is capable of, in embodiments, taxonomy generation, document classification and the like. The Data Acquisition module 100 provides for data acquisition (DA) and includes a file system (FS) and a database (DB). The DA is designed to supply documents from the Web or user FS and update them with required frequency. The Web is browsed through links that have been found in already downloaded documents. The user preferences can be adjusted using console screens to include domains of interest chosen by user. This configuration may be performed by Application Administrator.

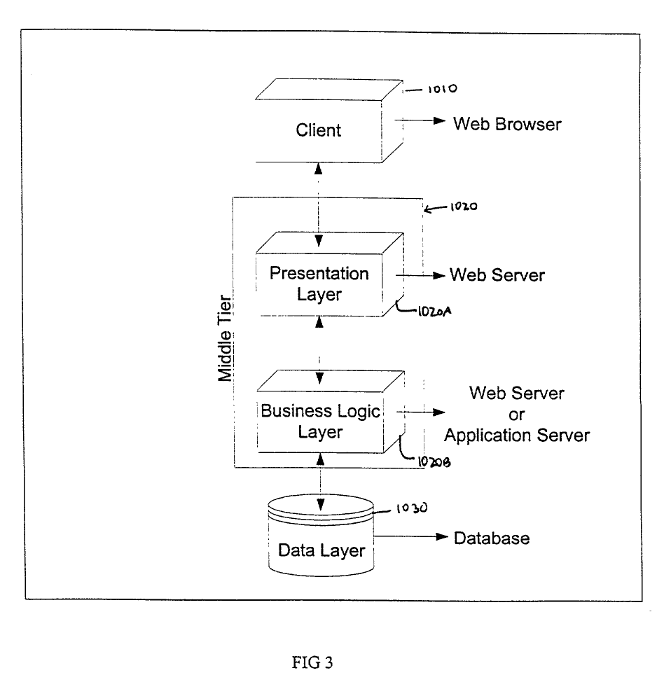

FIG. 3 shows a typical architecture of an Enterprise Web Application. This architecture, generally depicted as reference numeral 1000, includes four layers: a Client layer (Browser) 1010, a middle tier 1020 including a Presentation layer (Web Server) 1020A and a Business Logic layer (Application Server) 1020B, and a Data layer (Database) 1030. The Client layer (Browser) 1010 renders the web pages. The Presentation layer (Web Server) 1020A interprets the web pages submitted from the client and generates new web pages, and the Business Logic layer (Application Server) 1020B enforces validations and handles interactions with the database. The Data layer (Database) 1030 stores data between transactions of a Web-based enterprise application.

More specifically, the client layer 1010 is implemented as a web browser running on the user's client machine. The client layer 1010 displays data and allows the user to enter/update data. Broadly, one of two general approaches is used for building the client layer 1010:

A “dumb” HTML-only client: with this approach, virtually all the intelligence is placed in the middle tier. When the user submits the WebPages, all the validation is done in the middle tier and any errors are posted back to the client as a new page.

A semi-intelligent HTML/Dynamic HTML/JavaScript client: with this approach some intelligence is included in the WebPages which runs on the client. For example, the client will do some basic validations (e.g. ensure mandatory columns are completed before allowing the submit, check numeric columns are actually numbers, do simple calculations, etc.) The client may also include some dynamic HTML (e.g. hide fields when they are no longer applicable due to earlier selections, rebuild selection lists according to data entered earlier in the form, etc.) Note: client intelligence can be built using other browser scripting languages

The dumb client approach may be more cumbersome for end-users because it must go back-and-forth to the server for the most basic operation. Also, because lists are not built dynamically, it is easier for the user to inadvertently specify invalid combinations of inputs (and only discover the error on submission). The first argument in favor of the dumb client approach is that it tends to work with earlier versions of browsers (including non-mainstream browsers). As long as the browser understand HTML, it will generally work with the dumb client approach. The second argument in favor of the dumb client approach is that it provides a better separation of business logic (which should be kept in the business logic tier) and presentation (which should be limited to presenting the data).

The semi-intelligent client approaches are generally easier-to-use and require fewer communications back-and-forth from the server. Generally, Dynamic HTML and JavaScript is written to work with later versions of mainstream versions (a typical requirement should have IE 4 or later or Netscape 4 or later). Since the browser market has gravitated to Netscape™ and IE and the version 4 browsers have been available for several years, this requirement is generally not too onerous.

The presentation layer 1020A generates WebPages and includes dynamic content in the webpage. The dynamic content typically originates from a database (e.g. a list of matching products, a list of transaction conducted over the last month, etc.) Another function of the presentation layer 1020A is to “decode” the WebPages coming back from the client (e.g. find the user-entered data and pass that information onto the business logic layer). The presentation layer 1020A is preferably built using the Java solution using some combination of Servlets and JavaServer Pages (JSP). The presentation layer 1020A is generally implemented inside a Web Server (like Microsoft IIS, Apache WebServer, IBM Websphere, etc.) The Web Server can generally handle requests for several applications as well as requests for the site's static WebPages. Based on its initial configuration, the web server knows which application to forward the client-based request (or which static webpage to serve up).

A majority of the application logic is written in the business logic layer 1020B. The business logic layer 1020B includes:

performing all required calculations and validations,

managing workflow (including keeping track of session data), and

managing all data access for the presentation tier.

In modem web applications the business logic layer 1020B is frequently built using:

microsoft solution where COM object are built using with Visual Basic or C++

Java solution where Enterprise Java Beans (EJB) are built using Java.

Language-independent CORBA objects can also be built and easily accessed with a Java Presentation Tier.

The business logic layer 1020B is generally implemented inside an Application Server (like Microsoft MTS, Oracle Application Server, IBM Websphere, etc.) The Application Server generally automates a number of services such as transactions, security, persistence/connection pooling, messaging and name services. Isolating the business logic from these “house-keeping” activities allows the developer to focus on building application logic while application server vendors differentiate their products based on manageability, security, reliability, scalability and tools support.

The data layer 1030 is responsible for managing the data. In a simple example, the data layer 1030 may simply be a modem relational database. However, the data layer 1030 may include data access procedures to other data sources like hierarchical databases, legacy flat files, etc. The job of the data layer is to provide the business logic layer with required data when needed and to store data when requested. Generally speaking, the architect of FIG. 3 should aim to have little or no validation/business logic in the data layer 1030 since that logic belongs in the business logic layer. However, eradicating all business logic from the data tier is not always the best approach. For example, not null constraints and foreign key constraints can be considered “business rules” which should only be known to the business logic layer.

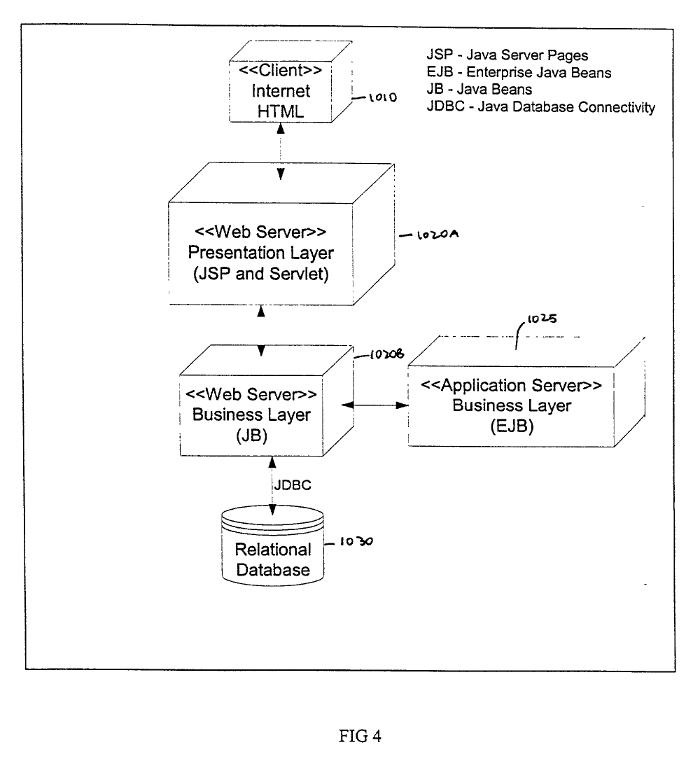

FIG. 4 shows the deployment of the system of FIG. 1 on a Java 2 Enterprise Edition (J2EE) architecture. The system of FIG. 4 uses an HTML client 1010 that optionally runs JavaScript. The Presentation layer 1020A is built using Java solution with a combination of Servlets and Java Server Pages (JSP) for generating web pages with dynamic content (typically originating from the database). The Presentation layer 1020A may be implemented within an Apache™ Web Server. The Servlets/JSP that run inside the Web Server may also parse web pages submitted from the client and pass them for handling to Enterprise Java Beans (EJBs)1025. The Business Logic layer 1020B may also be built using the Enterprise Java Beans and implemented inside the Web Server. (Note that the Business Logic layer 1020B may also be implemented within an Application Server). EJBs are responsible for validations and calculations, and provide data access (e.g., database I/O) for the application. EJBs access, in embodiments, an Oracle™ database through a JDBC interface. The data layer is preferably an Oracle™ relational database.

JDBC™ technology is an Application Programming Interface (API) that allows access to virtually any tabular data source from the Java programming language. JDBC provides cross-Database Management System (DBMS) connectivity to a wide range of Structured Query Language (SQL) databases, and with the JDBC API, it also provides access to other tabular data sources, such as spreadsheets or flat files. The JDBC API allows developers to take advantage of the Java platform's “Write Once, Run Anywhere”™ capabilities for industrial strength, cross-platform applications that require access to enterprise data. With a JDBC technology-enabled driver, a developer can easily connect all corporate data even in a heterogeneous enviromnent. The data layer is preferably an Oracle™ relational database.

In one embodiment, the platform for the database is Oracle 8I running on either Windows NT 4.0 Server or Oracle 8i Server. The hardware may be an Intel Pentium 400 Mhz/256 MB RAM /3 GB HDD. The web server may be implemented using Windows NT 4.0 Server, IIS 4.0 and a firewall is responsible for security of the system.

Data Acquisition Module

In general, the Data Acquisition module 100 includes intelligent “spiders” which are capable of crawling through the contents of the Internet, Intranet or other data sources 600 in order to retrieve textual information residing thereon. The retrieved textual information may also reside on the deep Web of the World Wide Web portion of the Internet. Thus, an entire source document may be retrieved from web sites, file systems, search engines and other databases accessible to the spiders. The retrieved documents may be scanned for all text and stored in a database along with some other document information (such as URL, language, size, dates, etc.) for further analysis. The spider uses links from documents to search further documents until no further links are found.

The spiders may be parameterized to adapt to various sites and specific customer needs, and may further be directed to explore the whole Internet from a starting address specified by the administrator. The spider may also be directed to restrict its crawl to a specific server, specific website, or even a specific file type. Based on the instruction it receives, the spider crawls recursively by following the links within the specified domain. An administrator is given the facility to specify the depth of the search and the types of files to be retrieved. The entire process of data acquisition using the spiders may be separate from the analysis process. (U.S. application serial no. (attorney docket no. 710003AA) describes the “spiders” with specificity and is incorporated herein in its entirely by reference.)

Data Preparation Module

The Data Preparation module 200 analyzes and processes documents retrieved by the Data Acquisition module 100. The function of this module 200 is to secure the infrastructure and standards for optimal document processing. By incorporating Computational Intelligence (CI) and statistical methods, the document information is analyzed and clustered using novel techniques for knowledge extraction (as discussed below).

A comprehensive dictionary is built based on the keywords identified by the algorithms from the entire text of the document, and not on the keywords specified by the document creator. This eliminates the scope of scamming where the creator may have wrongly meta-tagged keywords to attain a priority ranking. The text is parsed not merely for keywords or the number of its occurrences, but the context in which the word appeared. The whole document is identified by the knowledge that is represented in its contents. Based on such knowledge extracted from all the documents, the documents are clustered into meaningful groups (as a collective representation of the desired information) in a catalog tree in the Data Preparation Module 200. This is a static type of clustering; that is, the clustering of the documents do not change in response to a user query (as compared to the clustering which may be performed in the Dialog Control module 300). The results of document analysis and clustering information are stored in a database that is then used by the Dialog Control module 300.

FIG. 5 shows a block diagram of the data preparation module of the present invention. In particular, the Dialog Preparation module 200 includes an analyzer 210 which analyzes the documents collected from the Data Acquisition module 100, and stores this information in a database 220.1 A loader 230 then loads the analyzed (prepared) data into a data storage area 240.

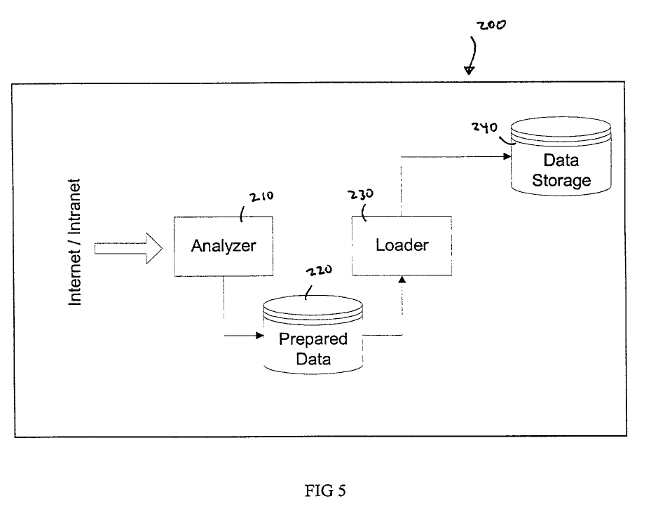

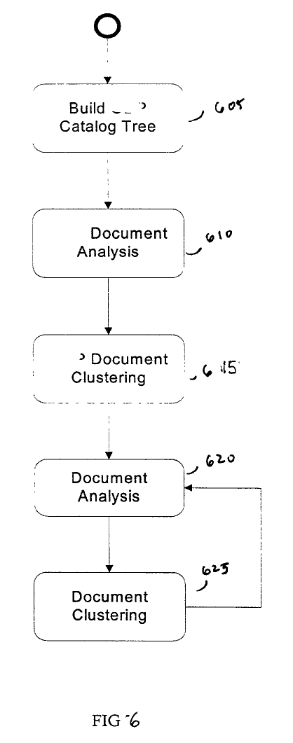

FIG. 6 is a flow diagram showing the steps of implementing the method of the present invention. The steps of the present invention may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. FIG. 6 may equally represent a high level block diagram of the system of the present invention, implementing the steps thereof.

In particular, FIG. 6 describes the sequence of steps for the analysis-clustering process. In step 605, the process creates a thematic catalog of documents on the basis of a pre-selected thematic structure of Web pages. In step 610, the documents from the selected structure, and the words contained therein, are analyzed for statistical information such as, for example, documents and word occurrences, identification of relationships between words, elimination of insignificant words, and extraction of word semantics. The step 610 may also construct an inter-connection (link) graph for the documents. In step 615, the analyzed Web catalog documents are then grouped into larger blocks, e.g., clusters. The clusters are constructed into a hierarchical structure based on pre-calculated data (discussed in greater detail below). In step 620, the documents are then analyzed. Similar to the analysis and clustering processes for the structure of documents, the source documents taken from the Internet and other sources are also analyzed and clustered in a recursive manner, in step 625, until there is no new document detected at the source. This sequence of steps for the analysis-clustering process (FIG. 6) is an option, and there is no need to use pre-selected thematic structure of Web pages.

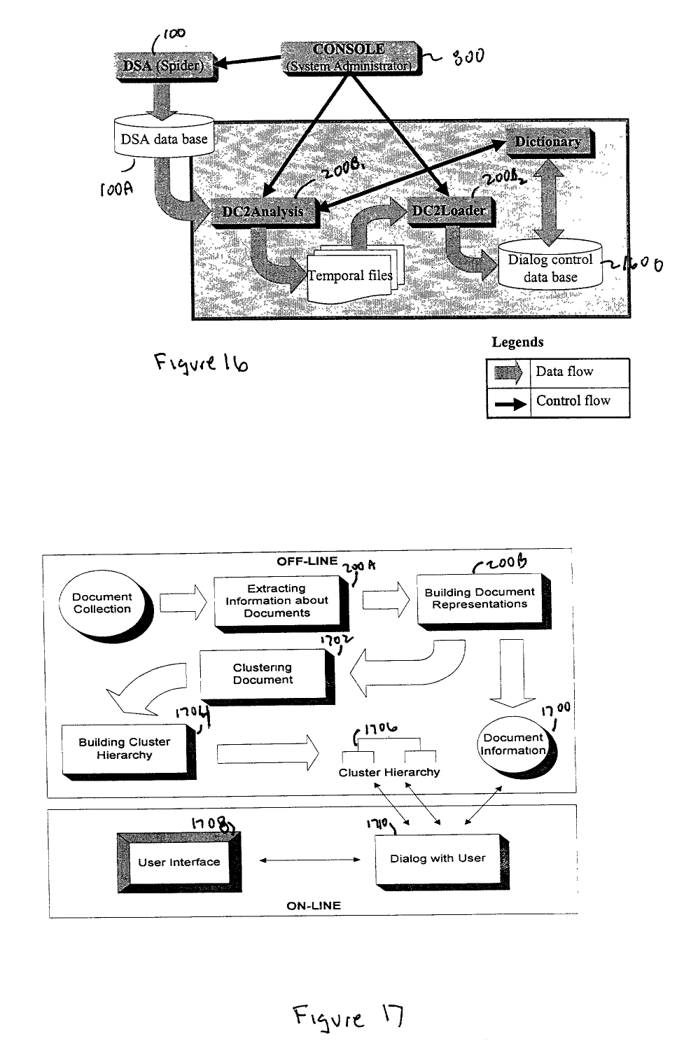

FIG. 7 shows a design consideration for implementing the method and system of the present invention. The functions of the data preparation are performed in the off-line mode 705 and the user dialog is performed in the on-line mode 710. There is an interaction between a user and the cluster hierarchy and the document information function performed in the data preparation. In this manner of on-line and off-line modes, the user will not experience a lag in the response time due to the analysis and clustering of the documents. (Refer to FIG. 17 for a more detailed discussion concerning this design consideration.)

In more specificfity, the Data Preparation module is, in embodiments, divided into two separate analytical modules, DC1 and DC2 modules. The DC1 module processes the HTML documents downloaded by the spider, tags the documents and computes statistics used thereafter. Two main stages of analysis are called analyzer and indexer, respectively. The dc1 analysis is implemented, in embodiments, using Java and Oracle 8 database with the Oracle InterMedia Text option. InterMedia may help clustering (with its reverted index of word and phrase occurrences in documents).

The DC2 module processes the HTML documents downloaded by the spider and generates for the documents specific tags such as, for example, the document title, the document language and summary, keywords for the document and the like. The procedure of automatic summary generation comprises assigning weights to words and computing the appropriate weights of sentences. The sentences are chosen along the criterion of coherence with the document profile. The purpose of both modules is to group documents by means of the best-suited phrase or word when it is not possible to find association-based clusterings in the clusters obtained on the stage of dc1 analysis.

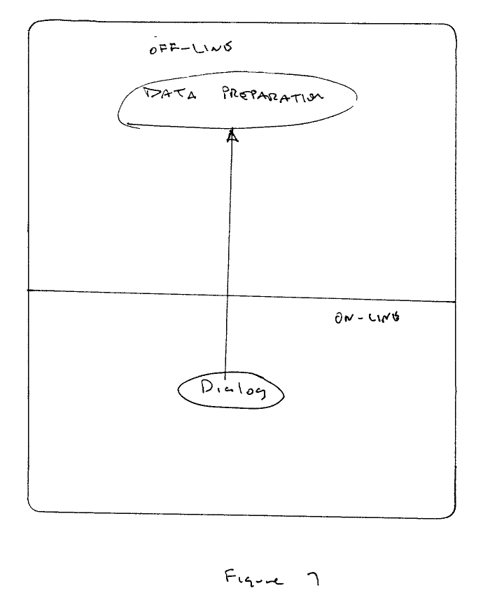

FIG. 8 shows a general data and control implementing the invention. Specifically, the spider module (data acquisition module 100) is designed to supply documents from the Web or user file systems such as Lotus Domino and the like (all referred to with reference numeral 100A) and updating them with required frequency. The Web is browsed through links that have been found in already downloaded documents. The user preferences can be adjusted using a console screen to include domains of interest chosen by the user. This configuration should be performed by the Application Administrator. Functional capabilities of the spider module include, for example, HTML documents, Lotus Notes or MS Office documents. Non-HTML documents are converted to HTML format by the converter process. As previously discussed, the data acquisition module 100 searches the downloaded document to find links pointing to other related sites in the Web. These links are then used in the sequel of scanning the Web.

The DC1 module 200A processes the HTML documents downloaded by the Data Acquisition module 100, tags them and computes statistics used thereafter. The analyzer process considers only these documents that are marked as ready for analysis. When the analyzer finishes, the documents are marked as already analyzed. Then, documents are tagged and stored in the database 804 for the needs of user interaction by means of the Dialog Module 300. Each HTML document may be described by the following tags:

<BODY>

<TITLE>

<URL>

<METAKEYWORDS>

<METADESC>

<LINK>

The HTML documents are also stored temporarily in a separate statistics database 803. The data gathered in this database is processed further by the indexer process which applies linguistic analysis of documents form (titles, headlines, body of the text) and its content (phrases and words). The indexer is also capable of upgrading a built-in dictionary which generates words that describe the document contents, creates indexes for documents in the database, associates the given document with other documents to create the concept hierarchy, clusters the documents using a tree-structure of concept hierarchy and generates a best-suited phrase for cluster description plus five most representative documents for the cluster. For the purpose of further processing (taxonomy builders) the following statistics my be generated:

50 best words or phrases for each document,

the automatically generated summary based on most representative sentences in the document.

The DC2 module 200B processes the HTML documents downloaded by the data acquisition module 100 and generates specific tags for the documents. Two main stages of DC2 analysis are referred to as dc2 analyzer and dc2loader, respectively. The dc2analyzer process uses marks already analyzed (referred to hereinafter as dc2analysis). It starts with generating a dictionary of all words appearing in the analyzed documents, and the documents are indexed with the words from the dictionary. The importance is assigned to each word in the document. The importance is a function of word appearances in the document, its position in the document and its occurrences in the links pointing to this document. Then, all the documents are tagged. Each HTML document may be described in the DC2 module 200B by the following tags:

URL—the document URL address

PAGE_TITLE—the document title

CREATION_DATE—the document creation date

DOC_SIZE—the document size in bytes

LANGUAGE—the document language

SUMMARY—the document summary

DESCRIPTION—the document description

KEYWORDS—list of the keywords for the document.

The language is detected automatically based on the frequencies of letter occurrences and co-occurrences. The best words for the document are found by computing relative word occurrence measured against the “background” (the content of the other documents in the same cluster). The procedure of automatic summary generation comprises assigning the weights to words and computing the appropriate weights of sentences. The sentences are chosen along the criterion of coherence with the document profile. The results of dc2analyzer are stored in temporary files and then uploaded to the database 300 by the dc2loader.

A Taxonomy (Skowron-Bazan) module 801 and a Taxonomy (Skowron 2) module 802 group documents by means of the best-suited phrase or word when it is not possible to find association-based clusterings in the clusters obtained on the stage of DC1 module 200A. The Skowron-Bazan Taxonomy Builder 800 is based on the idea of generation word conjunction templates best-suited for grouping documents. The Skowron 2 Taxonomy Builder 802, on the other hand, is based on the idea of approximative upper rough-set coverage of concepts of the parent cluster in terms of concepts appearing in the child cluster. The Skowron-Bazan Taxonomy Builder 800 is thus suited for single-parent hierarchies and the Skowron-2-Taxonomy Builder 802 allows for multiple-parent hierarchies.

The Skowron-Bazan Taxonomy Builder 800 comprises two processes: matrix and cluster. The matrix process generates a list of best words (or phrases) for each cluster and their occurrence matrix for the documents in the given cluster. Then the templates related to a joint appearance of words (or phrases) are computed by the cluster process and the tree-structure of taxonomy is derived from them. The cluster process splits too big word-asscociation -based clusters into subclusters using these statistics to identify best parent cluster and most discriminating significant words. The Skowron-2 Taxonomy Builder 802, on the other hand, comprises a completer and taxonomer process. The completer process adds new clusters based on word occurrence statistics, improving document coverage with clusters beyond word-association clustering. The taxonomer process splits clusters that were marked by the completer as too large. The taxonomer derives the subcluster from best characterizing words of the cluster and all its parents. (The functions associated with the matrix, taxonomer and completer processes are discussed in more detail below.)

The Dialogue module 300 assists the user in an interactive process of scanning the resources for the desired information. Also, some additional functions are supplied as preference configuration (Settings) and session maintenance. The Dialogue module 300 processes the query entered by the user and retrieves from the Database the appropriate tree-hierarchy. The hierarchy is the answer for the user-query and the dialog module makes its searching comfortable and efficient. The Dialogue module 300 also supports visualization of tags generated by the DC1 and DC2 modules 200A and 200B, respectively. Given a word, a phrase or an operator query, the Dialog module 300 groups the found documents into clusters labeled by the appropriate phrases narrowing the meaning of query.

Prior to further discussion, it is necessary to define the following terms in order to better understand the present invention.

Token: words/phrases found in documents during indexing them. Tokens may be single words, phrases or phrases found using simple heuristics (e.g., two or more consecutive words beginning with capital letters). Tokens may be used interchangeably with “word or phrase”.

Hint: a synonym for “token”.

Theme: a token found with heuristics or other method.

Cluster: a set of documents grouped together. Clusters and tokens are may be closely related. Each cluster has a single token describing it. The set of documents belonging to the cluster is defined as the set of all documents containing the token. But there may be more tokens than clusters—tokens contained in too few documents are ignored and not used as cluster descriptions.

Indexing: a process of extracting all tokens found in a set of documents, and finding for each token documents containing the token. This information may be stored in a data structure called index.

Gist: a summary for documents both from the general point of view or form the point of view of a given theme.

Process: This is one of three DC1 processes as discussed herein.

Processing: This term may be used to describe any part of any DC1 process.

### Discussion of DC1 Module

The following chart is provided as a summary of key algorithms used to implement many features of the remaining flow diagrams associated with the DC1 module 200A, as described herein. A discussion of the following flow diagrams for the functionality of the DC1 module 200A references the numbers to the associated key algorithms.

| No. | Process | Algorithm | Description |
|---|---|---|---|
| 1 | Analyzer | Extract | Ignore everything within SCRIPT |
| | | plain text | tags. Replace each tag with a single |
| | | from HTML. | space. Return the result. |
| 2 | Analyzer | Extract | Extract information from META, |
| | | metain- | TITLE and LINKS tags. |
| | | formation | |
| | | from HTML. | |
| 3 | Indexer & | Generate | Create reverted index of occurrences |
| | Statistics | clusters. | of words and phrases in documents. |
| | | | Phrases are taken from the |
| | | | knowledge base or recognized by |
| | | | primitive heuristics. Cluster is a set |
| | | | of documents containing the same |
| | | | word or phrase. Its label is defined |
| | | | as the word or phrase. |
| 4 | Indexer & | Generate | Build directed acyclic graph. Edge |
| | Statistics | cluster | (u,v) between phrases means, that u |
| | | hierarchy. | is the subphrase of v. |
| 5 | Indexer & | Generate | Count documents in each cluster. |
| | Statistics | cluster | Find the “most-representative-five” |
| | | descriptions. | documents for each cluster. |
| 6 | Indexer & | Generate | Find the best 50 (at most) words or |
| | Statistics | statistical | phrases for each document. |
| | | data for | |
| | | additional | |
| | | clustering. | |
| 7 | Indexer & | Generate | Extract a limited number of the most |
| | Statistics | document | representative sentences for the |
| | | summaries. | document. |

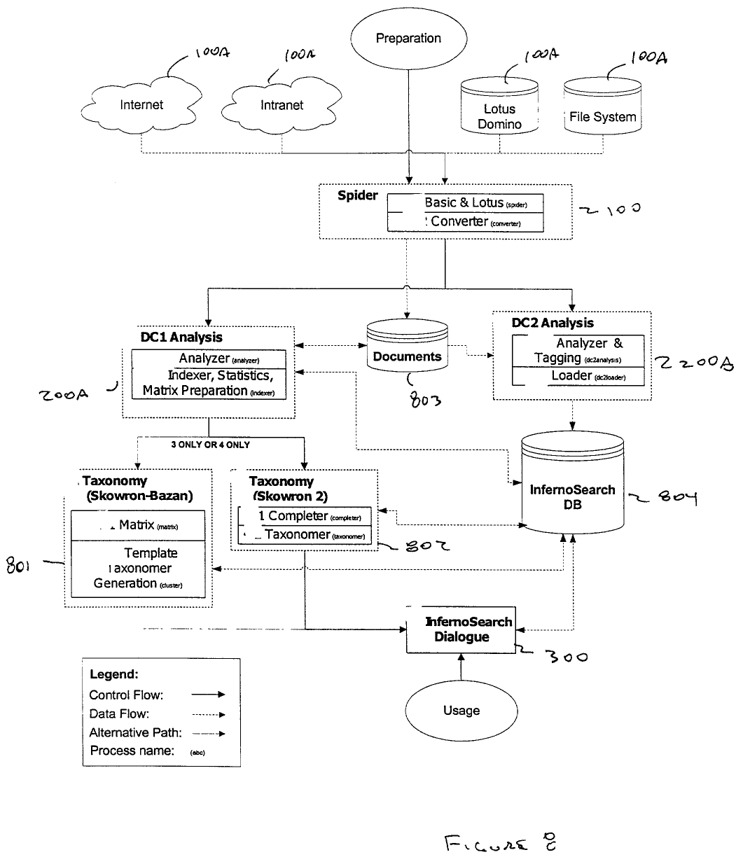

FIG. 9 shows a case diagram implementing steps of the overall design of the search engine. Specifically, the admisintrator beings processinging at block 900. The processing includes setting processes running at block 900A and stopping at block 900B as well as setting the process paratmeters at block 900C and monitoring the processes at block 900D. The monitoring of the processes may be saved in logs at block 900E. The data is prepared at block 901 which includes processing the documents at block 902 as well as analyzing the documents at block 904 and clustering the documents at block 906. Analyzing the documents includes extracting document meta information at block 904A for the clustering and processing. Meta information from HTML documents may include title, links, description and keywords. The clustering the documents includes generating a cluster heirarchy at block 906A, generting cluster descriptions at block 906B and assigning documents to elementary clusters at block 906C. the clustering description includes words or phrases that generate the cluster, the number of the documents in the cluster and, in embodiments, five documents that best represents the cluster. The generation of cluster hierarchy is preferably in the form of a connected directed acyclic graph. The limitations and requirements include:

Each cluster should have no more than 100 direct descendants.

Each document should be covered by at least one elementary cluster.

Each cluster should be defined as a set of documents containing the same word or phrase.

FIG. 10 shows an example for preparing data for use in dialog. As seen in this figure, the DC1 module is associated with running the process as well as analyzing and clustering the documents.

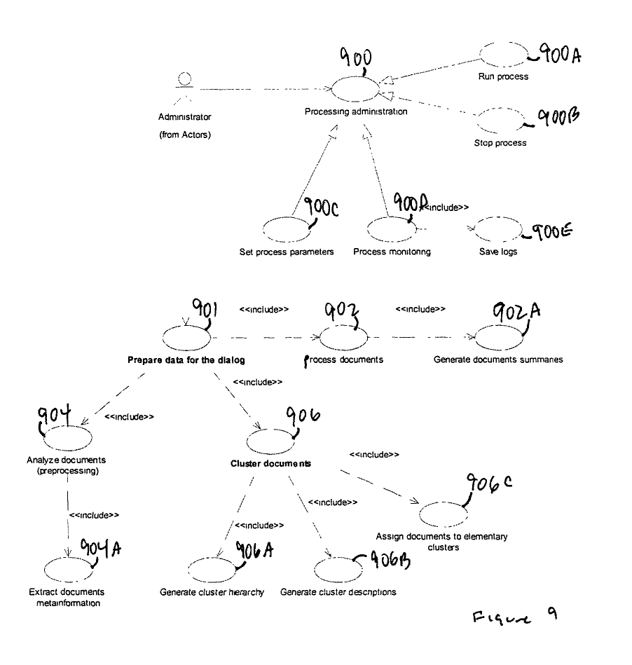

FIG. 11 shows a flow diagram for the example shown in FIG. 10. Specifically, in block 1102, the documents are analyzed (preprocessing). In block 1104, the documents are processed. Processing is responsible for the extraction of valuable information from the documents. The processing is different from analysis in two aspects: it assumes more complex analysis of the document content and it is (intentionally) independent of clustering. in block 1106, the documents are clustered. In block 1108, the data preparation is completed.

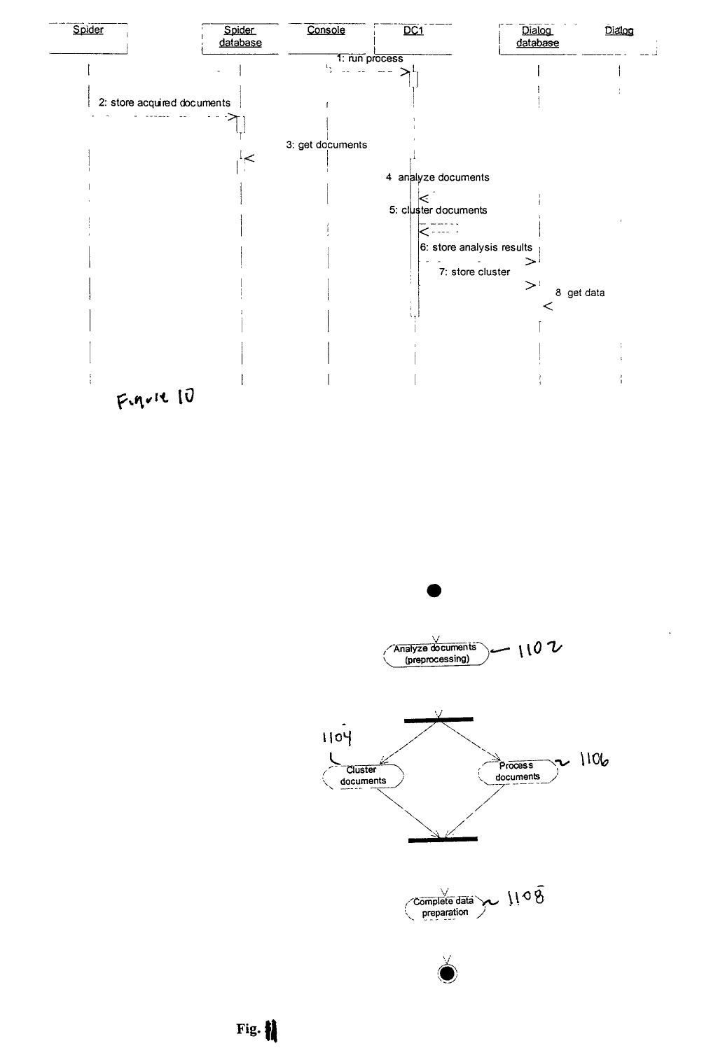

FIG. 12 is an example of the administrative aspect of the system functionality. In step 1201, the process parameters are set. In step 1202, the processes begins to run, using the DC1 processing. In step 1203, the process is monitored. In step 1205, the logs of information are saved. In step 1206, the process is again monitored and, in step 1207, the process is returned. The process is stopped in step 1208.

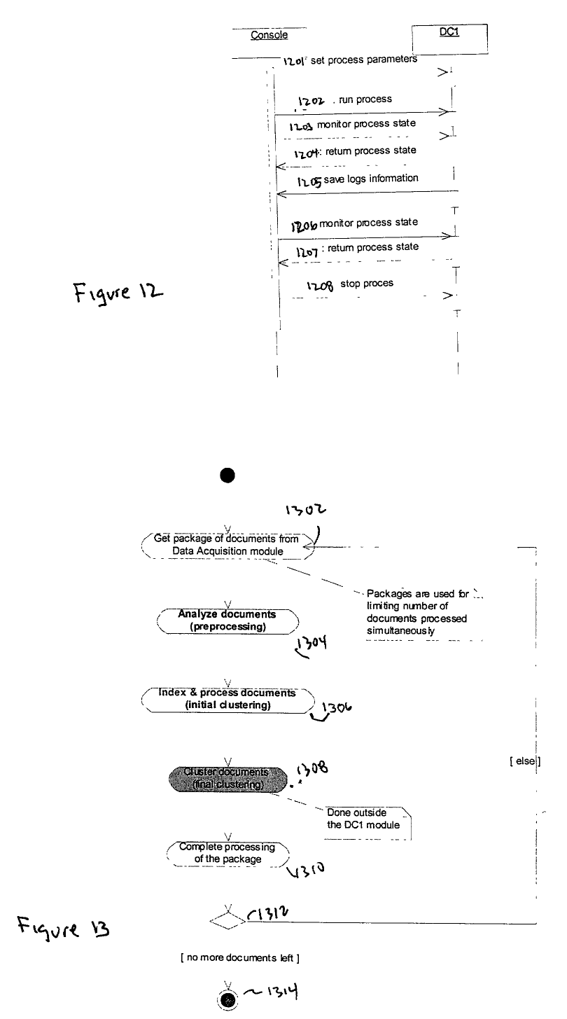

FIG. 13 shows a flow diagram of the DC1 processing scheme. The DC1 processes is performed in many incremental steps and, in embodiments, limits the size of simultaneously processed data. In step 1302, a package of documents is obtained. In step 1304, the documents are analyzed using key algorithms 1 and 2. In step 1306, the documents are indexed and processed using key algorithms 3, 4, 5, 6 and 7. In step 1308, the documents are clustered using key algorithms 3, 4 and 5. Additional clustering (adding more clusters) may be performed by the taxonomy subsystem (via the taxonomer module of the DC2 module 802 discussed below), which is external to the DC1 module 200A. In step 1310, the processing of the package is complete. In step 1312, a decision is made as to whether there are any further documents. If not, then the process ends at step 1314. If there are further documents, then the process returns to step 1302.

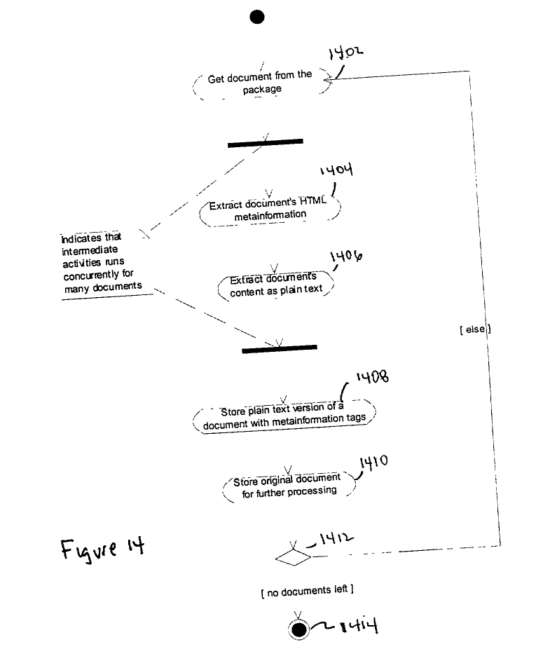

FIG. 14 is a flow diagram showing an analysis of the documents using the DC1 analysis. The DC1 analysis is used for fast documents preprocessing. This is performed for preparing documents to be looked for by the dialog. The document is preferably stored in two forms: (i) the pre-processed form with HTML tags removed (used by the dialog when searching information required by the user) and (ii) the original HTML form stored for indexing. It is noted that extracting the document meta information and plain text content activities may be realized as a single activity.

In step 1402 of Figure, the documents are obtained from the package. In this step, the memory cache is used to limit the number of database connections openings. In step 1404, the documents content and the plain text are extracted. In this step, key algorithm 1 is used which may run concurrently for many documents. In step 1406, the documents HTML meta information is extracted using key algorithm 2. The extraction may include the content of title, links, meta keywords and meta description tags, and may run concurrently for many documents. In step 1408, the plain text version of a document with meta information tags is stored using key algorithms 1 and 2. In step 1410, further original documents may be stored for further processing. In step 1412, a decision is made as to whether there are any further documents. If not, then the process ends at step 1414. If there are further documents, then the process returns to step 1402.

FIG. 15 shows a flow diagram describing the initial clustering of documents. In step 1502, the local reverted index and dictionary of words/phrases is created. In one embodiment, InterMedia's reverted index is created on DOCUMENTS_TMP table. The table may not contain too many rows, because of performance reasons. In step 1504, the document summaries are generated and statistical data for the final clustering are prepared. Key algorithms used for this step may include 6 and 7. In embodiments, the 50 best words/phrases for each document are generated in WORDS_TMP table. In step 1506 global data is updated with local data, implementing key algorithm 3. This step is performed by updating TOKENS table with information collected in TOKENS_TMP and copy summaries from GISTS to DOCUMENTS. InterMedia indexes may also be created on DOCUMENTS and TOKENS tables. In step 1508, clusters hierarchy is generated by implementing key algorithm 4. The clusters hierarchy may be generated into T2 TOKENS table using an “is-substring” rule. In step 1510, cluster descriptions are generated by implementing key algorithm 5. The best five documents for each cluster are preferably generated into DOC2TOKEN table. In step 1512, elementary clusters with too many documents is found by implementing key algorithm 6. In this step, elementary clusters containing too many documents are found and this information is stored into LEAVES. Also, documents are assigned to elementary clusters and this information is saved into DOCS_FOR_LEAVES table. In step 1514, documents not covered by any elementary cluster are found by implementing key algorithm 6. In step 1516, the processing of FIG. 15 is completed.

### Discussion of DC2 Module

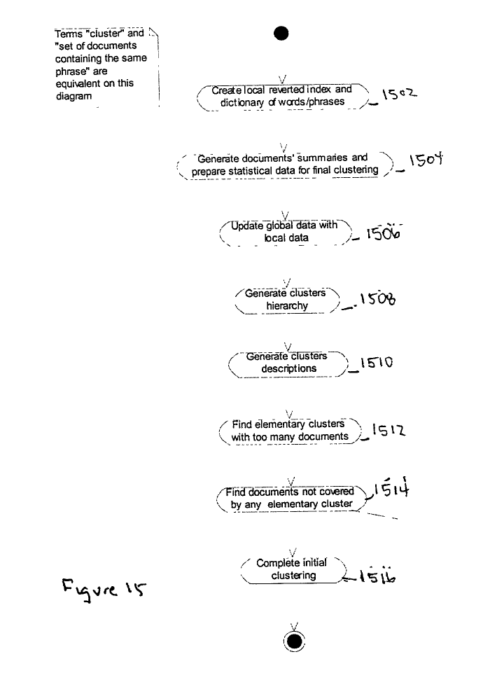

The DC2 module 200B has been designed to prepare data and dialog. The DC2 module 200B includes several independent components which may be used by other systems. In the current version, the DC2 module includes two sub-modules, dc2analysis 200B₁ and dc2loader 200B₂ (FIG. 16). The tasks of these sub modules are to analyze new documents assembled from the web and to load the analysis results to a database. More specifically, the DC2 submodules 200B₁ and 200B₂:

Extract statistical information about words and their occurrences in documents

Recognize semantic structures of documents (auto-tagging).

Load results into a data base.

The subsystem implements the following functions:

Analysis Control and Administration—sets the parameters for dc2analysis 200B₁;

Document Analysis—allows to compute the number of occurrences of words in documents and priorities of words in documents;

Document Tagging—assigns tags to the documents. The extracted tags are used later to generate XML stream for the document;

Dictionary Creation—document analysis and document tagging. The dictionary contains all words and phrases occurring in documents with their statistical information. It is updated during the analysis process and used later e.g., for document tagging;

Result Loading—loads the results of dc2analysis 200B₁ to the data base 1600.

From a logical point of view, the DC2 module 200B transforms unstructured textual data (web documents) into structured data (in form of tables in a relational data base). There are two sub-systems that keep interaction with the DC2 module, including the console 800 and Data Storage and Acquisition (DSA) module 100. In embodiments, the DC2 module performs its computation using two databases, the DSA database 100A and Dialog Control database 1600. The DC2 module obtains documents from the DSA database 100A and saves results to Dialog Control database 1600. The basic scenario of using the DC2 module includes, assuming that the System Administrator (CONSOLE) downloads a number of documents and wants to extract information about those documents:

1. Set parameters for dc2analysis.

2. Run dc2analysis in multi-thread environment. The results are stored in some temporal text files.

3. Set parameters for Dc2Loader.

4. Load the information from temporal text files into a data base.

The following is a chart of key algorithms used with the DC2 module 200B.

| Module | Algorithm | Description | |
|---|---|---|---|
| DC2 | Document | Summary provides a gist of the document: it | |
| Analyser | summar- | consists of a couple of sentences taken from the | |
| | ization | document which reflect the subject of the | |
| | | document. | |
| | | 1. | Compute the basic weight of a sentence as a |
| | | | sum of weights of words in the sentence. |
| | | | This weight is normalized to some extent |
| | | | with respect to the length of a sentence, and |
| | | | very short and very long sentences are |
| | | | penalized. |
| | | 2. | Select sentences with highest weights and |
| | | | order them according to the order in which |
| | | | they occur in the input text. There are |
| | | | limits on summary lengths, both in number |
| | | | of characters and in number of sentences. |
| DC2 | Language | Language recognition provides information | |
| Analyser | recog- | about the (main) language of the document; | |
| | nition | 1. | Statistical models for each language are |
| | | | applied to the summary; |
| | | 2. | the model that models the text best (i.e., the |
| | | | one that “predicts” the text best) is assumed |
| | | | to reflect the actual language of the |
| | | | summary and, hence, of the whole input |
| | | | text. |
| DC2 | Com- | Priority of word s is a sum of evaluating | |
| Analyser | puting the | measure of particular occurrence of s in the | |
| | priority of | document. The algorithm for computing the | |
| | words in | word priority is as follows: | |
| | document | First, we fix some constants: | |
| | | titleP = 31 (priority of words occurring in the | |
| | | title) | |
| | | headerP = 7 (priority of words occurring with | |
| | | header formats) | |
| | | empP = 3 (priority of words occurring with | |
| | | emphasis formats) | |
| | | Next, for every word s: | |
| | | s.priority = number of occurrences of s in | |
| | | the document; | |
| | | s.priority = s.priority + | |
| | | titleP*[number of occurrences of s in | |
| | | title] + | |
| | | (headerP + 5)*[number of occurrences of s | |
| | | with H1 tag] + | |
| | | (headerP + 4)*[number of occurrences of s | |
| | | with H2 tag] + | |
| | | (headerP + 3)* [number of occurrences of s | |
| | | with H3 tag] + | |
| | | (headerP + 2)*[number of occurrences of s | |
| | | with H4 tag] + | |
| | | (headerP + 1)*[number of occurrences of s | |
| | | with H5 tag] + | |
| | | (headerP)*[number of occurrences of s | |
| | | with H6 tag] + | |
| | | empP*[number of occurrences of s with | |
| | | some font format] | |
| DC2 | Keyword | Keywords are the most representative words for | |
| Analyser | extraction | a given document. Keywords are extracted as | |
| | | follows: | |
| | | 1. | For each word s occurring in the document |
| | | | D compute the importance index for s using |
| | | | the formula: |
| | | | Importance(s,D) = = |
| | | | [Priority(s,D)/size(D)] log[N/DF(s)] |
| | | 2. | Select the 5 words with highest importance |
| dc2 | Admin- | The main problem in parallel processing is | |
| analysis | istration | based on resource administration. In the | |
| | and | document analysis module, it is necessary to: | |
| | control of | • | guarantee that every document stored in |
| | document | | crawler data base is analyzed exactly one |
| | analysis | | time, |
| | processes | • | synchronize the access to the Dictionary |
| | | | which is a collection of all analyzed words. |
| | | In dc2analysis the Control and Administration | |
| | | algorithm is based on the construction of 3 | |
| | | kinds of threads: Provider, Analyzer and Saver. | |
| | | • | Provider downloads consecutive packages |
| | | | of documents from the crawler data base. |
| | | • | Analyzer gets documents from Provider, |
| | | | analyses them and sends results to Saver. |
| | | • | Saver saves results to disk. |

There is only one Provider and one Saver. The
number of Analyzers may be depended on the
number of terminals which are earmarked for
computation.

There is first an assumption that the set of documents searched by the user can be described by a certain specification which uses words. Under this assumption, the realization of the overall goal can be viewed as a realization of the following two objectives:

To find the optimal document-representation method.

To support the user with tools enabling the effective retrieval of specification for the document collection being in his/her scope of interest.

The second objective is related to the fact that the specification of the documents being looked after can actually be very complex and the user is not able to give the full and proper specification of them in advance. The initial specification formulated by the user will be further finessed as a result of the user's dialog with the system. Thus, taking into consideration the fact that the Internet is a large domain of documents, it is necessary, for the sake of overall system performance, to split the analysis into two stages. This is shown in FIG. 17.

FIG. 17 shows a first stage performed off-line and a second stage performed on-line. In the off-line stage, there is an analysis of documents retrieved from the Internet, building their internal descriptions and grouping them into hierarchical structures. In the second on-line stage, the interaction with the user takes place. The subsystem conducts a dialog with the user utilizing the structures and document description previously created off-line.

In FIG. 17, the DC2 sub-modules are labeled “Extracting Information about Documents” and “Building Document Representation”, and both are performed in the off-line mode. The “Extracting Information about Documents” 200A and “Building Document Representation” 200B provide information to both the document information at function block 1700 and the clustering of documents at function block 1702. The documents are then built into cluster hierarchies in function blocks 1704 and 1706. In the off-line mode, there is a dialog with the user at function block 1710 which communicates with the clustering hierarchy at function block 1706 and the document information at function block The user is able to retrieve this information at the user interface 1708.

It is noted that the dc2analysis controls the process of document analysis which has been downloaded by the DSA module (spider). The dc2analysis performs its task with the assumption that documents have been downloaded, filtered and saved in the DSA database. There are two main functions in the dc2analysis sub-module: Administration Control and Indexing Control (as will be described in more detail below). The dc2analysis may load the results into the database after analyzing every document, but it is an inefficient solution. In the DC2 subsystem, dc2analysis preferably saves results of all documents to text files and afterwards the Dc2Loader loads those files into the data base.

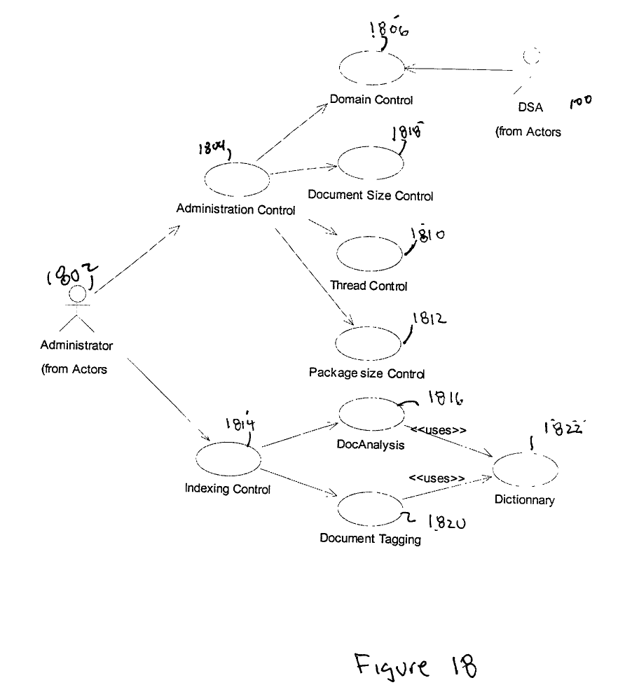

FIG. 18 shows the DC2 analysis sub-module. The Administrator 1802 starts all processes, sets parameters for the system and controls all the processes. The Administration Control 1804 sets the parameters for the dc2analysis . The Domain Control 1806 divides the documents which have been loaded by crawlers (module DSA 100) into different topic domains. This function determines the domain (or the set of domains) of documents to be analyzed by the dc2analysis. The documents which have been loaded are divided into different topic domains. This function determines the domain (or the set of domains) of documents to be analyzed by the dc2analysis . In the Document Size Control 1808, the analysis of very large documents is restricted to the first part (the prefix) and the last part (the suffix) of documents. It is then necessary to define three parameters:

The critical size of documents: when the size of document exceeds the critical size, the document will be recognized as large, and the only first part and last part of this document will be analyzed.

The prefix size: this parameter defines the length of the first part (without HTML tags) of large documents which are used to analyze.

The suffix size: this parameter defines the length of the last part of large documents which are used to analyze.

Still referring to FIG. 18, in the Thread Control 1810, documents are analyzed in parallel using multi-thread techniques. This function defines the number of operating threads, which will perform analysis process for one document at time. In the Package size Control 1812, the documents are received from the DSA module 100 and saved into the database in packets. This function defines the number of documents in one receiving package and the number of documents in one saving package. In the Indexing Control 1814, the dc2analysis is a multi-thread program. Analysis Control has been designed to make control and administration for a number of threads and also assures the communication with the databases, i.e., provides packages of documents from the DBA database and saves the results of analysis into temporal files. In the DocAnalysis 1816, the main process of dc2analysis is provided. The indexing process is based on:

computing the number of occurrences of words on documents

computing the priority of words on documents. The priority of words is related to number of occurrences and their formats.

In Document Tagging 1820, the dc2analysis assigns tags to the documents. The extracted tags are used later to generate XML stream for the document. A dictionary 1822 is also provided, which is a collection of all words occurring in the analyzed documents. The dictionary may be synchronically accessible.

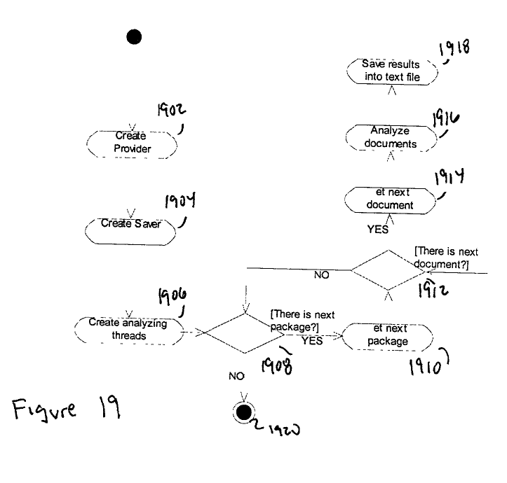

FIG. 19 is a flow diagram implementing the steps for the indexing control of the DC2Analysis. In step 1902, a provided is created; that is, a thread is created to control document providing processes. In step 1904, a thread to control document saving processes is created by the present invention. In step 1906, an analyzer of (asynchronous) threads is created to control document analyzing processes. In step 1908, a determination is made as to whether there are any packages in the provider. If not, then the process ends at step 1920. Is there are packages, then the next package is obtained in step 1910 from the provider. A determination is then made as to whether there are any documents in step 1912. If not, the control returns to step 1908. If there are further documents, then the next document is obtained in step 1914 and analyzed in step 1916. In step 1918, the results are saved in a text file. The process then reverts to step 912.

FIG. 20 is a flow diagram implementing the steps for the DocAnalysis of FIG. 18. In step 2002, the HTML document (for a given URL address) is imported from the DSA database. In step 2004, the HTML document is parsed (i.e., split it into separated lexemes (word and html tag)). In step 2006, a determination is made as to whether there is a next lexeme. If there is no lexeme, then the priorities of all words occurring in the document is computed in step 2008. If there is a next lexeme, then that lexeme is obtained from the document in step 2010. In step 2012, a determination is made as to which type of information is the lexeme. If the document contains a word, then the identification of the word from the word dictionary is obtained in step 2014. In step 2016, the statistics of the word occurrence are updated. In step 2018, a determination is then made as to whether the word occurrence is in the local dictionary. If not, the word is inserted into the local dictionary, in step 2020, and the local dictionary is updated with the statistics of the word in step 2022. If the local dictionary includes the word, then the process flows directly to step 2022. The dictionary is created in such a way that it is able to check if the word has existed. If the word has existed, then the dictionary returns the ID of this word (otherwise the dictionary inserts the word into the database and returns its ID). Thereafter, the process again reverts to step 2006. If a determination is made in step 2012 that the document has an HTML tag, the state machine is changed in step 2024 and thereafter the process returns to step 2016. The state machine informs the user about the actual format of the current point in the document.

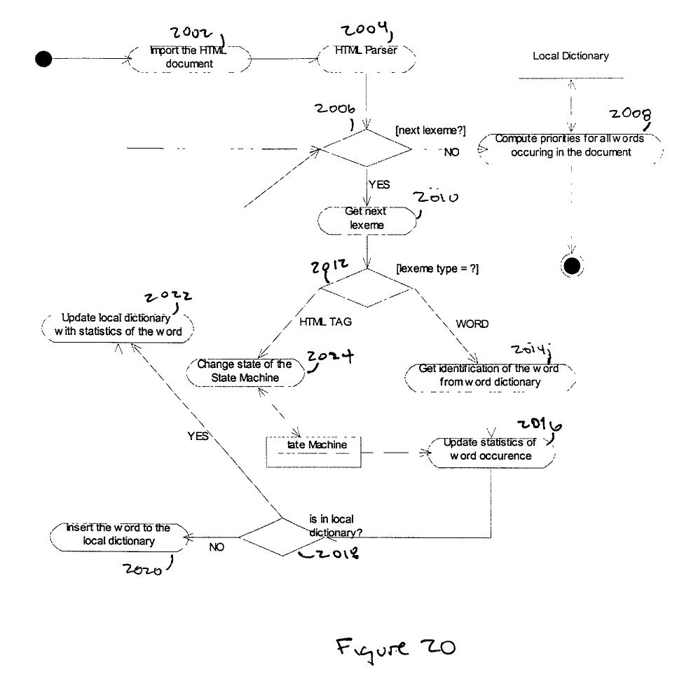

FIG. 21 is a diagram outlining the document tagging of FIG. 18. In the General Tagging block 2102, there are three kinds of information included: keywords, summaries and language. In the Keyword Extraction block 2103, a list of five most significant words is generated for the document. In the language Recognition and Summarizing block 2104, the summary provides a gist of the document. The gist includes a couple of sentences taken from the document which reflect the subject of the document. The language provides information about the (main) language of the document. In the Special Tagging block 2106, the following tags may be generated, with other tags also contemplated for use with the present invention.

URL—the address url of document

PAGE_TITLE —document title

CREATION_DATE—the creation data of document

DOC_SIZE—the size of document (in bytes)

LANGUAGE—the language of document

SUMMARY—the summary of document

DESCRIPTION—short description of document

KEYWORDS—the list of keywords

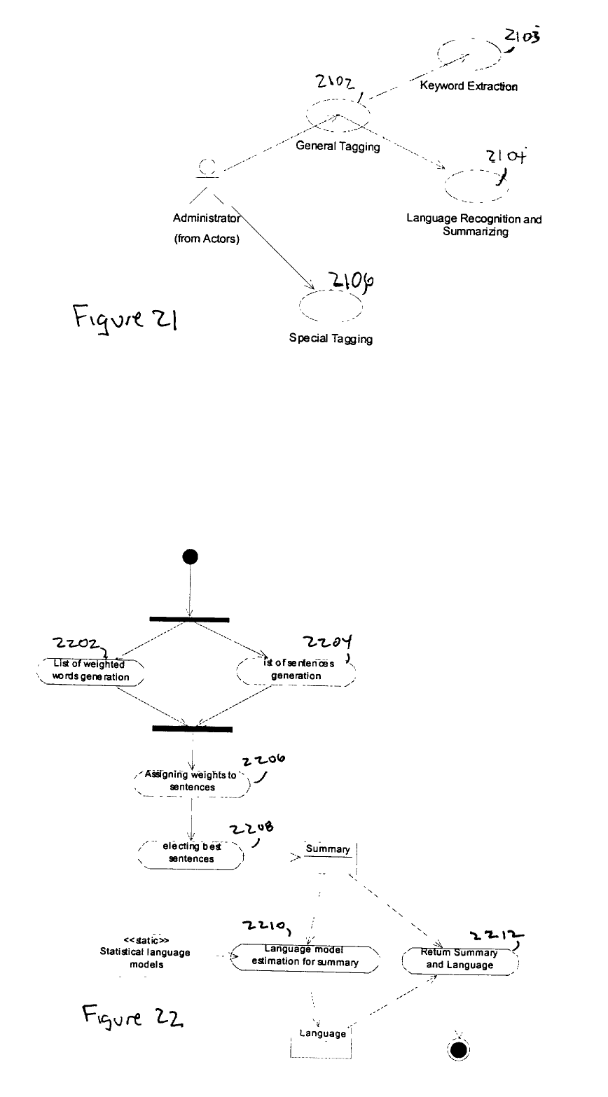

FIG. 22 is a flow diagram implementing the steps of language recognition and summarizing. In step 2202, a list of weighted words (list of words with priorities) is generated by the present invention. In step 2204, a list of sentences is generated. In doing so, the input text is “tokenized” into sentences. A number of heuristics is assumed to ensure a relatively intelligent text splitting (e.g., text is not split on abbreviations like “Mr.” or “Ltd.”, etc.). Weights to the sentences are then assigned in step 2206. The basic weight of a sentence is, in embodiments, the sum of weights of words in the sentence. This weight may be normalized to some extent with respect to the length of a sentence, and very short and very long sentences may be penalized. In step 2208, the best sentences are selected with the highest weights for the summary and ordered according to the order in which they occur in the input text. There should be limits on summary lengths, both in number of characters and in number of sentences. In step 2210, the statistical models for each language are applied to the summary; the model that models the text best (i.e., the one that “predicts” the text best) is assumed to reflect the actual language of the summary and, hence, of the whole input text. In step 2212, the results of text summarization and language guessing is returned.

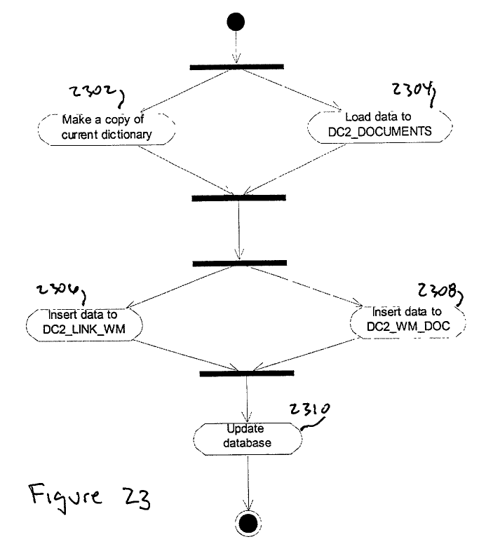

FIG. 23 is a flow diagram implementing the steps of the DC2Loader of the present invention. In step 2302, a copy of the current dictionary is made by the present invention. In step 2304, the data is loaded to DC2_DOCUMENTS. The data is then inserted into DC2_LINK_WM and DC2_WM-DOC in steps 2306 and 2308, respectively. The database is then updated in step 2310.

### Discussion of Taxonomy

The Skowron-Bazon taxonomy (Matrix) module 801 is intended to extend possible dialogs with the user prepared by the module DC1Analysis. This is done because, for example, generated clusters by the dc1 analysis module are not small enough to be easily handled in dialog with user. The Matrix module 801 is a part of the system responsible for off-line data preparation (as shown in 17). The objective of the matrix module 801 is to re-cluster those clusters for which maximal cluster size, specified by a user, is exceeded. This involves:

splitting clusters into tree structure, so that, every leaf of that tree, called elementary cluster, has less number of documents than specified by a user

describing new created clusters in a human-understandable way.

The matrix module 801 implements the document re-clustering. This includes splitting big clusters created by dc1 analysis into cluster hierarchy (directed acyclic graph). The hierarchy generated by matrix module should satisfy the following requirement:

The navigation structure should be locally small and, hence easy to understand by a human.

Generation of cluster descriptions.

Additional functions include preparing information data concerned with clusters, e.g., top five documents for every new cluster, number of documents in clusters. Also, additional functions may include collaboration with the console, including starting, stopping and monitoring processes.

There are two typical scenarios of use of the matrix process connected to the taxonomy based on templates and taxonomy based on alternatives. In the first case, matrix process iterates over all clusters prepared by dc1 analysis process (these are those clusters which exceeded the required cluster size). For every such cluster, matrix process generates information about this cluster and saves it to files. Then, the matrix process runs a Template Taxonomy Generation module which uses those files, creates taxonomy for loaded files and saves results to text files. These files can be then used in the process of clustering completion. In the second case, matrix is used many times by the process for building taxonomy based on alternatives. Single running of matrix processes single cluster and generates information about that cluster. In sum, the first case matrix is the main program for generating taxonomy, while the second case matrix is used as a part of the program for alternative taxonomy (see appropriate documentation).

The key algorithms used for taxonomy are summarized in the following chart.

| No. | Algorithm | Description |
|---|---|---|
| 1 | find top words for group of | Find words which on the one |
| | documents | hand are representative for the |
| | | group of documents and on the |
| | | other hand allow to split |
| | | cluster into smaller clusters. |
| 2 | generate matrix of | Generate matrix containing |
| | occurrences | information about occurrences |
| | | (or not) of top words in |
| | | documents from cluster. |

One of the main requirements for the matrix is to have the elementary clusters with less documents than a number specified by a user. A second requirement for the matrix is that the clusters should be labeled by single phrases or words which are good descriptions for the whole group of documents and should distinguish clusters appearing at the same level of cluster hierarchy.

Because of efficient reasons not all documents in cluster are considered in searching top words for cluster. Instead, only a sample of documents is chosen, where size of the sample can be set by a user. Searching for top words is preferably based on the information computed by InterMedia, i.e. the word priority of document. To calculate a score for a word in the document, Oracle™ uses inverse frequency algorithm based on Salton's formula. For a word in a document to score high, it must occur frequently in the document but infrequently in the document set as a whole. Moreover, cutting of noisy words is used. All words occurring in 10% of documents or more are assumed to be “noisy” words. Such words are not taken into account while searching for top words.

Because top words are used to split the cluster into smaller clusters, “good” words are not those which occur in all or almost all documents. Good words, for example,

should be descriptive, i.e. not common words

should be representative for the cluster

should enable splitting cluster into smaller clusters.

The matrix module also sets the number of top words and the size of documents sample. It also changes lower and upper thresholds, which describe what is the minimal and maximal coverage of any word from top word. It happens that there are documents from the sample which are not covered by any of found top words. This effect can be fixed by searching additional words only for the not covered documents. User can set the appropriate parameters to enable this process.

The template taxonomy generation module (TTG) loads data sets from files, generates template taxonomy and saves results into files. The goal of the TTG is to generate template taxonomy for the given data (loaded from text files). Results of computation are saved into text files. All data for TTG comes from dc2analysis.

The TTG functionality includes:

Loading dictionary of words, which are important in a considered set of documents.

Loading data table with information about occurrence of words from the dictionary in documents.

Building template taxonomy for the loaded data.

Saving results of computation into text files.

Log file generation.

The TTG design includes a Taxonomy Builder which loads data from files, builds taxonomy, and saves results to files. The TTG design further includes Template Family storage (which keeps information about computed templates for the given date) and Table storage (which keeps loaded tables). Additionally, the TTG design includes Dictionary storage which keeps information about loaded dictionary of words from documents. A typical TTG working scenario could be divided into 4 following steps:

1. Taxonomy Builder loads dictionary from text file;

2. Taxonomy Builder loads table with information about occurrence of words from the dictionary in documents form text file;

3. Taxonomy Builder creates taxonomy for loaded data; and

4. Taxonomy Builder saves results to text files.

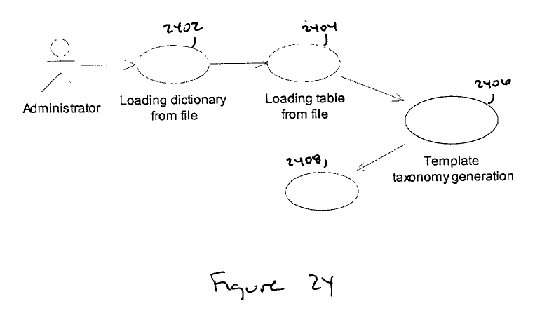

FIG. 24 shows a case diagram for the TTG. At function block 2402, the loading dictionary begins with monitoring of its work through a log file. At function block 2404, the table is loaded and monitored through the log file. At function block 2406, the template taxonomy generation is started and is further monitored through the log file. To build the template taxonomy generation;

1. A template is generated covering of table with information about occurrence of words from dictionary in documents,

2. Nodes of the taxonomy tree are created; and

3. The connections between nodes in taxonomy tree are made.

At function block 2408, the results are saved and, again, monitored through the log file.

The Skowron 2 taxonomy module 802 includes a completer module and a taxonomer module. The completer module is implemented in order to improve dialog quality by covering documents not belonging to any DC1 elementary clusters. In this way, the completer process creates additional clusters containing (directly or through subclusters) these uncovered documents. By way of example and referring to FIG. 25, InterMedia cluster for the phrase car 2500 is provided. This cluster may contain several InterMedia sub clusters, e.g., car rental 2500A, car dealers, 2500B. The problem is that many documents will contain the phrase car, but will not contain any longer phrase with car as subphrase.

These documents will not be covered by any of the subclusters car rental 2500A, car dealers 2500B, etc. In such a case, the role of completer module is to create clusters at the same level as subclusters car rental, car dealers, etc., covering these uncovered documents. If these new clusters are too large, they will be split into smaller clusters by the taxonomer module 802.

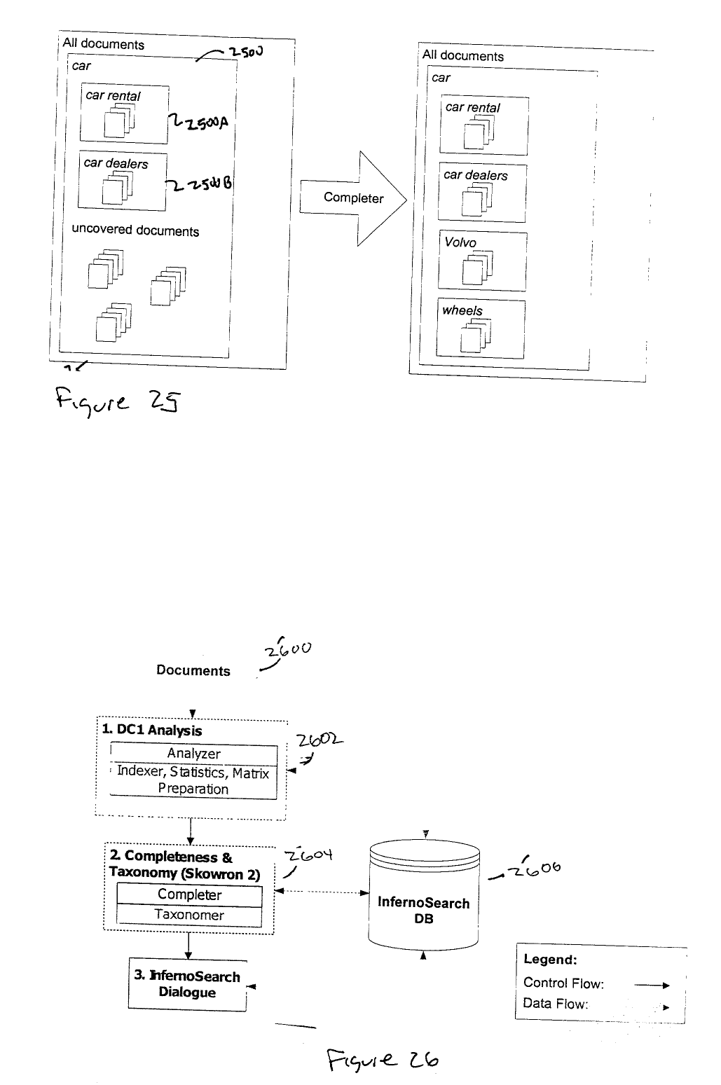

FIG. 26 is a high-level view of the completer module external interactions. The completer (represented in function block 2604) runs after DC 1 analysis in function block 2602 and prior to the taxonomer (as discussed in more detail below). The completer module creates new clusters based on information provided by dc1 analysis. And, the taxonomer module splits large clusters both created by DC 1 analysis (InterMedia clusters) and by the taxonomer module (phrase clusters). Flow of documents is obtained from the database (function block 2600) and information flows between the taxonomy module and the database (represented at function block 2606).

In using the completer module, it is assumed, in embodiments, that the System Administrator used the DC1 analysis module to analyze a large set of documents and now wants to improve coverage of these documents by running the completer module. The following basis steps should thus be followed:

1. Ensure that the entire dc1 analysis completed successfully.

2. Set parameters for completer, taxonomer and matrix modules.

3. Run the completer module in multi-thread environment (in order to create new clusters).

4. Run the taxonomer module in multi-thread environment (in order to split clusters that are too large).

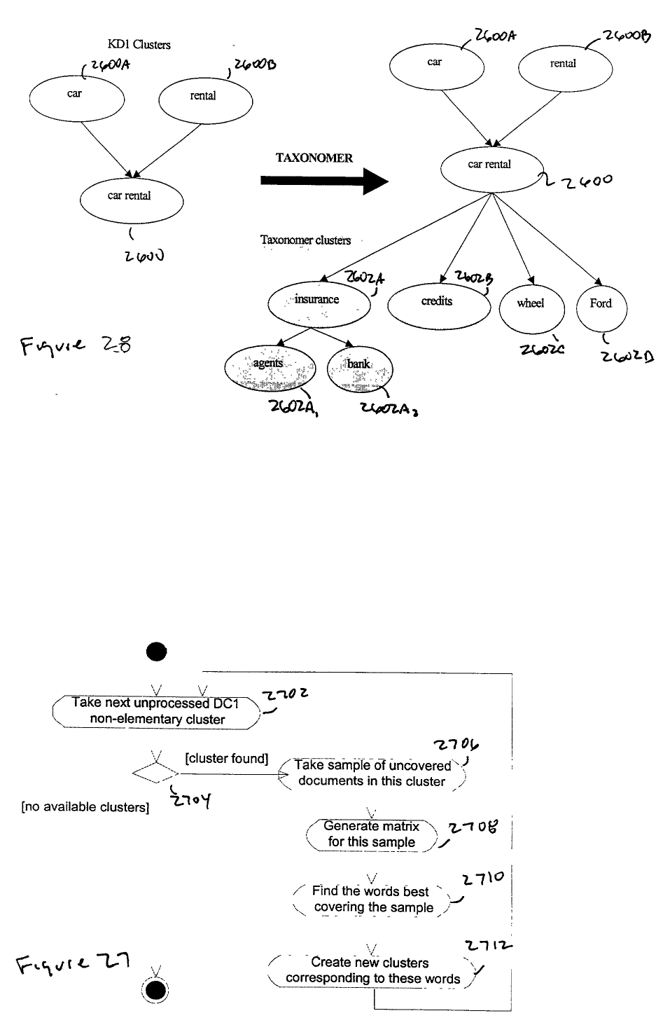

FIG. 27 shows a flow diagram of the steps implementing the processes of the completer module. First, the data for the completer module is prepared by the DC 1 module 801. This data contains the list of clusters containing the uncovered documents, along with the list of all uncovered documents in each of these clusters. Having given clusters and uncovered documents inside them, the completer module, in step 2702, obtains the next processed DC1 non-elementary cluster. In step 2704, a determination is made as to whether any clusters are found. If no clusters are found, the process ends. If clusters are found, then for each given cluster C and the set of uncovered documents D inside this cluster a statistical sample is taken of the uncovered documents sample D in step 2706. In step 2708, a matrix is generated for the sample (using the matrix module). In step 2710, the words which best cover the same are found. In step 2712, new clusters are created corresponding to the best words found in step 2710. In other words, based on the matrix data, a set of phrases, Cover(sample(D))={w₁, . . . , Wₙ}, is found which becomes the names of new clusters. The new cluster labeled with the phrase wᵢ will contain all the documents containing this phrase. The ideal situation is when every document contains at least one of the phrases w₁, . . . , wₙ, and the number of documents containing the phrase wᵢ (for each i) is not too large. This number multiplied by size(D)/size(sample(D)) should, in embodiments, not exceed the maximal size of the cluster that the taxonomer module is able to split. Finding of the set Cover(sample(D)) is performed according to greedy algorithm: first, the word covering the most of the documents is chosen, then the word covering the most documents that are not covered yet is chosen, and so on. The information on new clusters and the best documents may then be inserted into dialog tables. It should be noted that each subcluster added to the cluster by the completer module is processed once. Thus, if the new documents are fed into the engine and the completer process is run, the new subclusters are not added by completer module to the previously analyzed clusters.

The taxonomer module of the Skowron 2 taxonomy module 802 was implemented in order to improve dialog quality by decomposition existing DC1 elementary clusters or clusters created during the completer process which contain too many documents. The scope of the taxonomer module is restricted to creating clusters which satisfy completeness and decomposition conditions. The clusters are found during preprocessing before starting main computations and their size is determined by the analysis and completer processes. The taxonomy process creates a hierarchy of clusters (subtrees) containing smaller set documents than their ancestors which satisfy approximately completeness and decomposition conditions. The conditions state that

“the probability of existing big elementary clusters in the hierarchy is small (decomposition condition) and the probability that a document from a parent cluster is not present in a child cluster is very low (completeness condition)”.

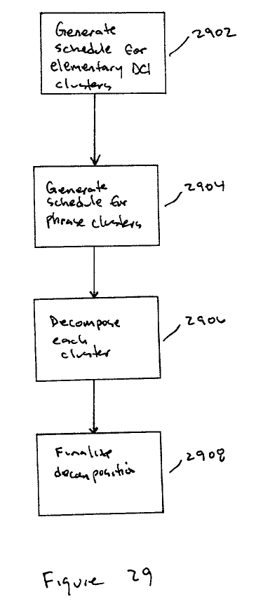

For example, referring to FIG. 28, the DC1 elementary cluster for the phrase car rental 2600 has two parents: car 2600A and rental 2600B. Assume that the cluster contains too many documents and hence the problem is to decompose the cluster due to its size. The decomposition includes the creation of subtree of clusters with root in the car rental cluster. The leaves of the subtree satisfy (approximately) the completeness and decomposition conditions. The procedure creates at most two additional levels of clusters. These clusters include insurance 2602A, credits 2602B, wheel 2602C and Ford 2602D, as well as agents 2602A, and bank 2602A₂. The first level could be indirect and elementary phrase clusters (indirect cluster: insurance and elementary clusters: agents, bank) and on the second only elementary clusters (credits, wheel, Ford).

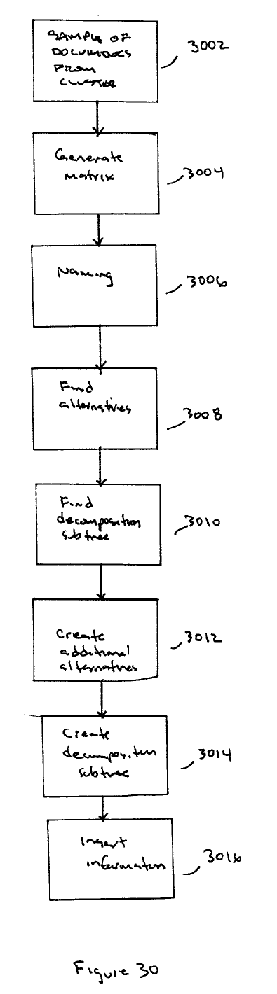

The data for the taxonomer module is prepared by the DC1 module and the completer module. In fact the taxonomy module uses mainly size of document set of cluster for determining which of them have to be split. The taxonomer works according to the following general steps shown in flow diagram of FIG. 29. In step 2902, a schedule is generated for the elementary clusters produced by the DC Analysis. This list of clusters should be greater than taxonomy.maxPhraseClusterSize property and the elementary DC1 clusters (i.e., tokens.is_elementary=1 in database). In step 2904, a schedule is generated for the phrase clusters produced by the completer module. This list should include clusters which size is greater than taxonomy.maxPhraseClusterSize property and phrase type (i.e., tokens.type=4 in database). In step 2906, each of the clusters are decomposed as discussed in more detail with reference to FIG. 30. In step 2908, the decomposition is finalized. This includes updating some of the global database structures.

FIG. 30 is a flow diagram showing the substeps of the decomposition step 2906 of FIG. 29. First, given cluster C and its phrase p:

Let docs(q1, . . , qn) determine set of documents which contains within body all phrases q1, q2, . . . , qn.

Let p=p1 p2. . . pn, where p1, . . . , pn are simple words.

Now, in step 3002, the sample of documents are taken from cluster C: sample(C). The statistical sample (which size is determined by taxonomy.sampleSize property) is taken if one of the following conditions is satisfied: (i) the number of documents in the cluster C (in docs(p)) is greater than taxonomy. bigCluster property or (ii) if the cluster C is elementary DC1 cluster and size of the set docs(p1, . . . , pn) is greater than taxonomy.bigCluster property. If so, then let alpha(C)=taxonomy.sampleSize/size(C); otherwise all documents in the cluster are taken (alpha=1). In step 3004, a matrix (words occurrence table for most relevant words) is generated for the sample. The matrix module is used to generate the matrix (referred to as child matrix). In step 3006, if the cluster C is elementary DC1 cluster and alpha=1, then the matrix for the documents form docs(p1, . . . , pn) is generated (referred to as parent matrix). Otherwise all references to the parent matrix are assumed to be equal to the child matrix. In step 3008, the set of alternatives which will be the base for the decomposition process is found based on the matrix data. The alternative is a pair <q, Q>, where q is a phrase and Q is a set of phrases. Note that set Q includes child matrix phrases q₁, . . . , qₖ which have the following property: size of set of documents determined by phrases q and qi in the sample has size not grather than max(alpha(C) *taxonomy. max PhraseClusterSize, 10) and not less then max(alpha(C) *taxonomy.minPhraseClusterSize,1). The inequalities allow to satisfy approximately decomposition condition. The phrase q is taken from the parent matrix data, and q is not in Q. The alternatives are created sequentially. The general heuristics of this step includes:

1. find the best phrase q from parent matrix data which has not been used in alternatives;

2. find members q₁, . . . , qₖ of Q from the child matrix data according to the condition that the size of set (docs(q1) ∪ . . . ∪ docs(qk) ∪ sample(C) should be closed to docs(q) ∪ sample(C) in a sense of given distance (available types of distances XOR, OR, ENTROPY, INCLUSION);

3. if a phrase is used as q or in Q then global priority of the phrase is decremented.

Note also that in the taxonomer module two searching heuristics are implemented: greedy and hill climbing. (Notation: docs(<q,{q₁, . . . , qₖ}>)=docs(q₁) ∪ . . . ∪ docs(qk).)

Still referring to FIG. 30, in step 3010, based on the set of alternatives the decomposition subtree is found for the cluster. The general condition for this step is to find the smallest subet Alt={<q₁, Q₁>, . . . ,<qm, Qm>} of alternatives which gives the highest coverage coefficient which is determined as |(docs(Q1)∪ . . . ∪ docs(Qm)) ∩ sample(C)|. In step 3012, if the coverage coefficient does not satisfy the completeness condition then create additional alternatives called singletons. A singleton is a special kind of alternative in which set Q has exactly one element equal to phrase q. Searching conditions and the methods are the same as above. In step 3014, a decomposition tree is created such that for each created alternative 21 q, Q>:

1. if Q has exactly one element s create child cluster with the phrase s and set type of the new cluster as elementary phrase;

2. if Q has elements q₁, . . . , qₖ create child cluster C′ with the main phrase q and create its children C₁, . . . , Cₖ with the main phrases equal q₁, . . . , qₖ respectively. Set type for C′ equal indirect and for C₁, . . . , Cₖ—elementary;

3. set C as not elementary cluster;

4. set approximate size of the new clusters as |docs(p,q′)|/alpha where q′ is main phrase for the cluster. In step 3016, the information on the new clusters and the best documents in these clusters are inserted into dialog tables.

Dialog Control Module

The Dialog Control module 300 offers an intelligent dialog between the user and the search process; that is, the Dialog Control module 300 allows interactive construction of an approximate description of a set of documents requested by a user. Using the knowledge built by the Data Preparation module 200, based on optimal document representation, the user is presented with clusters of documents that guide the user in logically narrowing down the search in a top-down manner. This mechanism expedites the search process since the user can exclude irrelevant sites or sites of less interest in favor of more relevant sites that are grouped within a cluster. In this manner, the user is precluded from having to review individual sites to discover their content since that content would already have been identified and categorized into clusters. The function of the Dialog Control module 300 may thus support the user with tools that enable an effective construction of the search query within the scope of interest. The Dialog Control module 300 may also be responsible for content-related dialog with the user.

The Dialog Control module 300 allows the user's requests to be described as Boolean functions (called patterns) built from atomic formulas (words or phrases) where the variables are phrases of text. For example, a pattern may be represented as:

[‘Banach’ AND (‘theorem’ OR ‘space’)] OR ‘analytical function’

Every pattern represents a set of documents, where the pattern is “true”. In the simplest form, a pattern may be defined as any set of words (so-called standard pattern). For example, the pattern W is present in the document D if all words from W appear in D. The Dialog Control module 300 retrieves standard patterns, which characterise the query. These standard patterns are returned as possibilities found by the system.

The patterns may be implemented, for example, by a set of five classes, including Pattern and subclasses Phrase, Or, And, and Neg. The following code illustrates the use of these classes

void main()
{
Pattern *P = new Pattern();

Phrase fraza(“Project”);

char T[256]=“”;

P = &(fraza * “House”);

P = &(*P - “Construction”);

printf(P->Pat2Text(T));

}

The result of this function is the message: “Project * House-Construction”

The clustering of the documents, on the other hand, provides communication needs between the graphical user interface and the Dialog Control module 300. On the basis of the dialog with the user, the graphical user interface receives a user's query which is then transferred into the pattern. At this stage, a list of clusters is created which is displayed in the dialog window as the result of the search. Both the use of patterning and clustering are described in more detail in the co-pending application U.S. application Ser. No. ______, incorporated in its entirety herein.

By way of general example, the user formulates a query as a set T of words, which should appear in the retrieved documents. The Dialog Control module 300 replies in two steps:

(i) It retrieves all documents DOC(T) which include words from T.

(ii) It groups the retrieved documents into similarity clusters and returns to the user standard patterns of these groups. This step, by itself can, be defined as:

“For the given set of documents Z, find sufficiently large sets of words T₁, . . . Tₖ which appear in sufficiently many documents from the set Z. Using data mining terminology, these sets are called ‘frequent sets’ or ‘patterns’.”

After these steps, the user constructs a new query (taking advantage from the results of the previous query and the standard patterns already found). It is expected that the new query is more precise and better describes user's requirements.

User Interface Module

The User Interface module 400 comprises a set of interactive graphical user interface web-frames. The graphical representation may be dynamically constructed using as many clusters of data as are identified for each search. The display of information may include labeled bars, i.e., “Selection”, “Navigation” and “Options”. The labeled bars are preferably drop-down controls which allow the user to enter or select various controls, options or actions for using the engine. By way of example,

The “Selection” bar allows user entry and specification of compound search criteria with the possibility of defining either mutually exclusive or inclusive logical conditions for each argument. The user may select or deselect any cluster by clicking on a plus or minus sign that will appear next to each cluster of information.

The “Navigation” bar allows the user access to familiar controls such as “forward” or “backward”, print a page, return to home, add a page to favorites and the like.

The “Options” bar presents a drop down list or controls allowing the user to specify the context of the graphical depiction, e.g., magnify images playback control for playing sound (midi, wav, etc.) files, and other options that will determine the look and feel of the user interface.

In one preferred embodiment, the platform for the database is Oracle 8I and running on either Windows NT 4.0 Server or Oracle 8i Server. The hardware may be an Intel Pentium 40 Mhz/256 MB RAM /3 GB HDD. The web server is implemented using Windows NT 4.0 Server, IIS 4.0 and a firewall is responsible for security of the system. It provides secure access to web servers. The system runs on Windows NT 4.0 Server, Microsoft Proxy 3.

While the invention has been described in terms of several embodiments, those skilled in the art will recognize that the invention can be practiced with modification within the spirit and scope of the appended claims. The following claims are in no way intended to limit the scope of the invention to specific embodiments.

1. A method for analyzing and processing documents, comprising the steps of:
building a dictionary based on keywords from an entire text of the documents,
analyzing text of the documents for the keywords or a number of occurrences of the keywords and a context in which the keywords appear in the text; and
clustering documents into groups of clusters based on information obtained in the analyzing step, wherein each cluster of the groups of clusters includes a set of documents containing a same word or phrase.

2. The method of claim 1, wherein the clustering step clusters the documents in a catalog tree.

3. The method of claim 1, wherein the clustering step is a static clustering that does not change in response to a user query.

4. The method of claim 1, further comprising the step of splitting the groups of clusters into subclusters, the splitting step including:
finding words which are representative for each of the group of clusters;
generating a matrix containing information about occurrences of the top words in the documents from the groups of clusters; and
creating new clusters based on the generating step which corresponds to the top words and a set of phrases.

5. The method of claim 1, wherein the analyzing step includes analyzing the documents for statistical information including word occurrences, identification of relationships between words, elimination of insignificant words and extraction of word semantics.

6. The method of claim 1, wherein the clustering step is performed recursively.

7. The method of claim 1, wherein the analyzing and clustering steps are performed off line.

8. The method of claim 1, further comprising the step of generating specific tags for the documents including at least one of document title, document language and summary and the keywords.

9. The method of claim 1, further comprising the step of assigning weights to the words and computing the appropriate weights of sentences within the documents.

10. The method of claim 1, further comprising the step of summary generation of the documents, the summary generation being based on the assigned weights to the words and the appropriate weights of the sentences.

11. The method of claim 1, wherein the analyzing step is performed on only selected documents which are marked.

12. The method of claim 11, wherein the documents are HTML documents.

13. The method of claim 12, wherein the analyzing step includes applying linguistic analysis to the documents, the linguistic analysis being performed on one of titles, headlines and body of the text, and content including at least one of phrases and the words.

14. The method of claim 13, wherein the dictionary generates words that describe the contents of the documents, creates indexes for the documents, associates the documents with other documents to create concept hierarchy, clusters the documents using a tree-structure of the concept hierarchy and generates a best-suited phrase for cluster description.

15. The method of claim 14, wherein the dictionary includes all words appearing in the analyzed documents, and the documents are indexed with the words from the dictionary.

16. The method of claim 15, wherein importance is assigned to each word in the document, the importance being a function of word appearances in the document, position in the document and occurrences in links pointing to the document.

17. The method of claim 1, further comprising detecting a language of the documents based on frequencies of letter occurrences and co-occurrences in the words.

18. The method of claim 1, wherein the clustering step is based on one of (i) a best-suited phrase or word from the documents and (ii) generation word conjunction templates for grouping the documents.

19. The method of claim 1, wherein the analyzing step includes extracting document meta information.

20. The method of claim 1, further comprising the steps of
generating a cluster heirarchy for the groups of clusters;
generting cluster descriptions, the clustering descriptions including words or phrases that generate a cluster of the groups of clusters and the number of the documents in the cluster; and
assigning the documents to elementary clusters and indirect clusters.

21. The method of claim 20, wherein a cluster of the groups of clusters is split into subclusters using statistics to identify best parent cluster and most discriminating significant word in the cluster.

22. The method of claim 1, further comprising the step of processing the documents, the processing including:
creating reverted index of occurrences of words and phrases in the documents;
building a directed acyclic graph; and
extracting a limited number of representative sentences or words or phrases for the document.

23. The method of claim 21, wherein the processing step is independent of the clustering step and is performed in incremental steps.

24. The method of claim 23, wherein the clustering step includes the steps of:
creating reverted index of occurrences of words and phrases in the documents;
building a directed acyclic graph; and
counting the documents in each group of clusters.

25. The method of claim 24, wherein the clustering step further includes:
generating document summaries and statistical data for the groups of clusters;
updating global data by using the document summaries;
generating cluster descriptions of the groups of clusters by finding representative documents in the each cluster of the groups of clusters;
finding elementary clusters associated with the groups of clusters which contain more than a predetermined size of the documents; and
storing the elementary clusters in storage.

26. The method of claim 1, wherein the analyzing step includes transforming unstructured textual data associated with the documents into structured data in form of tables.

27. The method of claim 1, wherein the analyzing step includes the steps of:
computing a basic weight of a sentence as a sum of weights of the words in the sentence;
normalizing the weight with respect to a length of the sentence;
selecting sentences with highest weights;
ordering the sentences with the highest weights in an order which they occur in the input text;
providing a priority to the words by evaluating a measure of particular occurrence of the words in the documents; and
extracting the keywords from the documents which are representative for a given document, the keywords being extracted as follows:
for each word s occurring in the document D compute an importance index for s using the formula:
$$Importance ( s , D ) = \\ = [ Priority ( s , D ) / size ( D ) ] log [ N / DF ( s ) ]$$
where N is a number of all the documents and DF(s) is the number of all the documents which contain the word s.

28. The method of claim 1, wherein the documents are divided into different topic domains and restricted to document size.

29. The method of claim 28, wherein a critical size of the documents is determined prior to the analyzing step such that when the critical size exceeds a predetermined size, the analyzing step only analyzes a first part and a last part of the documents.

30. The method of claim 1, wherein the analyzing step includes splitting the documents into separate lexemes including words and hypertext markup language (HTML) tags.

31. The method of claim 30, wherein the analyzing step further comprises the steps of:
determining whether there is a next lexeme in the documents;
computing the priorities of all of the words in the documents if the next lexeme is found;
determining which type of information is the lexeme; and
if the documents contain a word lexeme then:
obtain an identification of the word from the dictionary;
update statistics of the word occurrence; and
return an ID of the word.

32. A system for analyzing and processing documents, comprising the steps of:
a module for building a dictionary based on the keywords from an entire text of the documents,
a module for analyzing text of the documents for the keywords or a number of occurrences of the keywords and a context in which the keywords appear in the text; and
a module for clustering documents into groups of clusters based on information obtained in the analyzing step, wherein each cluster of the group of clusters is a set of documents containing a same word or phrase.

33. A machine readable medium containing code for analyzing and processing documents, comprising the steps of:
building a dictionary based on the keywords from an entire text of the documents,
analyzing text of the documents for the keywords or a number of occurrences of the keywords and a context in which the keywords appear in the text; and
clustering documents into groups of clusters based on information obtained in the analyzing step, wherein each cluster of the group of clusters is a set of documents containing a same word or phrase.
